(19) United States
(12) Patent Application Publication
(10) Pub. No.: US 2026/0134361 A1
(43) Pub. Date: May 14, 2026

(54) INFORMATION PROCESSING SYSTEM AND INFORMATION PROCESSING APPARATUS

(71) Applicant: Hidetoshi KIKUCHI, Tokyo (JP)

(72) Inventor: Hidetoshi KIKUCHI, Tokyo (JP)

(73) Assignee: Ricoh Company, Ltd., Tokyo (JP)

(21) Appl. No.: 19/376,247

(22) Filed: Oct. 31, 2025

(30) Foreign Application Priority Data
Nov. 12, 2024 (JP) 2024-197129
Jul. 25, 2025 (JP) 2025-124654

(51) Int. Cl. G06Q 10/0631; G10L 15/18; G10L 25/66

(52) U.S. Cl. CPC G06Q 10/063112; G10L 15/1815; G10L 25/66

(57) ABSTRACT

An information processing system includes circuitry. The circuitry acquires speech data including speech content of a target person whose skill is to be identified. The circuitry generates first instruction information for instructing to output information for identifying a skill related to the speech content among a plurality of skills that are predefined based on the speech content included in the speech data. The circuitry transmits the speech data and the first instruction information to a generative AI. The circuitry receives a first response to the first instruction information from the generative AI. The circuitry identifies one or more skills among the plurality of skills based on information for identifying the skill included in the first response. The circuitry registers the identified one or more skills and the target person in a first storage unit in association with each other.

### CROSS-REFERENCE TO RELATED APPLICATIONS

This patent application is based on and claims priority pursuant to 35 U.S.C. § 119(a) to Japanese Patent Application No. 2024-197129, filed on Nov. 12, 2024, and 2025-124654, filed on Jul. 25, 2025, in the Japan Patent Office, the entire disclosure of which is hereby incorporated by reference herein.

### BACKGROUND

### Technical Field

The present disclosure relates to an information processing system and an information processing method.

Related Art

It is desired to grasp the skill of each individual belonging to an organization such as a company in order to implement the arrangement of personnel at appropriate places. Although it is conceivable to grasp the skill by referring to a personal history or by conducting an interview, both approaches are not economical because of a large load on the persons concerned.

On the other hand, a technique of analyzing an input natural language and registering an individual skill based on a skill mapping rule has been proposed.

### SUMMARY

The present disclosure described herein provides an information processing system. The information processing system includes circuitry. The circuitry acquires speech data including speech content of a target person whose skill is to be identified. The circuitry generates first instruction information for instructing to output information for identifying a skill related to the speech content among a plurality of skills that are predefined based on the speech content included in the speech data. The circuitry transmits the speech data and the first instruction information to a generative AI. The circuitry receives a first response to the first instruction information from the generative AI. The circuitry identifies one or more skills among the plurality of skills based on information for identifying the skill included in the first response. The circuitry registers the identified one or more skills and the target person in a first storage unit in association with each other.

The present disclosure described herein provides an information processing method. The information processing method includes acquiring speech data including speech content of a target person whose skill is to be identified. The information processing method includes generating first instruction information for instructing to output information for identifying a skill related to the speech content among a plurality of skills that are predefined based on the speech content included in the speech data. The information processing method includes transmitting the speech data and the first instruction information to a generative AI. The information processing method includes receiving a first response to the first instruction information from the generative AI. The information processing method includes identifying one or more skills among the plurality of skills based on the information for identifying the skill included in the first response. The information processing method includes registering the identified one or more skills and the target person in a first memory in association with each other.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to a first embodiment;

FIG. 2 is a diagram illustrating a hardware configuration of an information processing apparatus according to the first embodiment;

FIG. 3 is a diagram illustrating a functional configuration of the information processing system according to the first embodiment;

FIG. 4 is a flowchart of a process of specifying a skill of a target person according to the first embodiment;

FIG. 5 is a diagram illustrating a configuration of a determination condition storage unit according to the first embodiment;

FIG. 6 is a diagram illustrating a configuration of a skill list storage unit according to the first embodiment;

FIG. 7 is a diagram illustrating a configuration of a human-resource master storage unit according to the first embodiment;

FIG. 8 is a flowchart of a processing procedure of a process of updating correspondence information according to the first embodiment;

FIG. 9 is a diagram illustrating a configuration of a determination condition storage unit according to a second embodiment;

FIG. 10 is a diagram illustrating a configuration of a determination condition storage unit according to a third embodiment;

FIG. 11 is a diagram illustrating a fourth embodiment;

FIG. 12 is a diagram illustrating a functional configuration of an information processing system according to a fifth embodiment;

FIG. 13 is a flowchart of a procedure of a human-resource search process according to a fifth embodiment;

FIG. 14 is a diagram illustrating a display example of a search condition input screen;

FIG. 15 is a diagram illustrating a display example of a search result screen;

FIG. 16 is a diagram illustrating a configuration of an information processing system according to a sixth embodiment;

FIG. 17 is a diagram illustrating a functional configuration of the information processing system according to the sixth embodiment;

FIG. 18 is a diagram illustrating a display example of a registration inquiry screen according to an eighth embodiment;

FIG. 19 is a diagram illustrating a display example of a possessed-skill update notification screen according to a ninth embodiment;

FIG. 20 is a diagram illustrating a display example of a human-resource portal screen according to a tenth embodiment;

FIG. 21 is a diagram illustrating a display example of a principal information screen according to the tenth embodiment;

FIG. 22 is a diagram illustrating a display example of a department information screen according to the tenth embodiment;

FIG. 23 is a diagram illustrating a display example of a personal information screen according to the tenth embodiment;

FIG. 24 is a diagram illustrating a functional configuration of an information processing system according to an eleventh embodiment;

FIG. 25 is a diagram illustrating a display example of a personal information screen according to the eleventh embodiment;

FIG. 26 is a diagram illustrating a display example of a department information screen according to the eleventh embodiment;

FIG. 27 is a diagram illustrating a display example of a personal information screen according to the eleventh embodiment;

FIG. 28 is a diagram illustrating a functional configuration of a terminal according to a twelfth embodiment; and

FIG. 29 is a sequence diagram illustrating a processing procedure related to screen transition according to the twelfth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

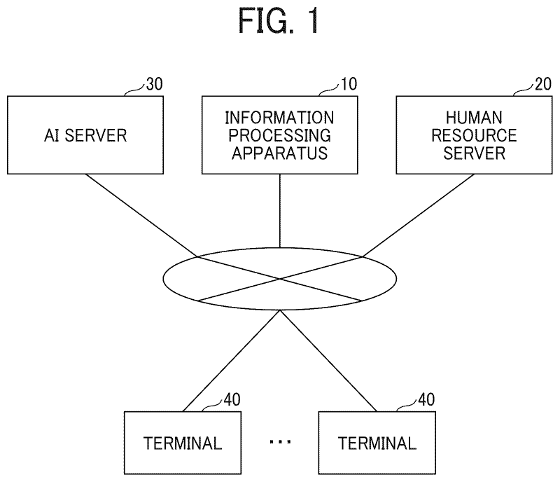

Embodiments of the present disclosure are described below with reference to the accompanying drawings. FIG. 1 is a diagram illustrating a configuration of an information processing system according to a first embodiment. In FIG. 1, the information processing system includes a human resource server 20, an information processing apparatus 10, an Artificial Intelligence (AI) server 30, and one or more terminals 40. The terminal 40 is connected to the human resource server 20 and the information processing apparatus 10 via a network such as the Internet or a local area network (LAN). The information processing apparatus 10 is connected to the human resource server 20 and the AI server 30 via a network such as the Internet or a LAN.

The human resource server 20 is one or more computers that manage information (in the following description, referred to as “skill information”) indicating what kind of skill each individual belonging to a certain organization (in the following description, referred to as “organization X”) such as a company has.

The terminal 40 is a device that uploads (transmits), to the information processing apparatus 10, data from which the skill information is extracted. The terminal 40 is any device or apparatus that can be operated by a user, such as a personal computer, a tablet terminal, or a smartphone. In the present embodiment, voice data obtained by recording a speech of a target person whose skill is to be identified (in the following description, referred to simply as a “target person”) is an example of an extraction source from which the skill information of the target person is extracted.

The information processing apparatus 10 is one or more computers that register skill information related to a target person in the human resource server 20 based on the voice data received from the terminal 40. The information processing apparatus 10 converts the voice data into text data (in the following description, referred to as “speech data”) including speech content in the voice data to identify the skill of the target person related to the voice data from the speech data. The “skill of the target person” refers to a skill that the target person is assumed to have.

In the present embodiment, an example will be described in which the organization X is a company that sells cosmetics and a salesperson of the cosmetics is a target person. The speech data is text data indicating speech content of the voice data in which speech made by a salesperson of cosmetics regarding description of a product is recorded, e.g., when the salesperson serves a customer and when a meeting is held in a company. Any method may be performed to record the voice data. The information processing apparatus 10 may automatically register the skill information of each salesperson based on the speech data of each salesperson. Thus, even when the organization X has several thousand salespersons nationwide, the skill information of each salesperson can be efficiently collected.

The AI server 30 is one or more computers that provide a generative AI. The generative AI is used to identify the skill of the target person from the speech data. The AI server 30 may not be a component unique to the information processing system. For example, the AI server 30 may be a cloud server that provides the generative AI to the public.

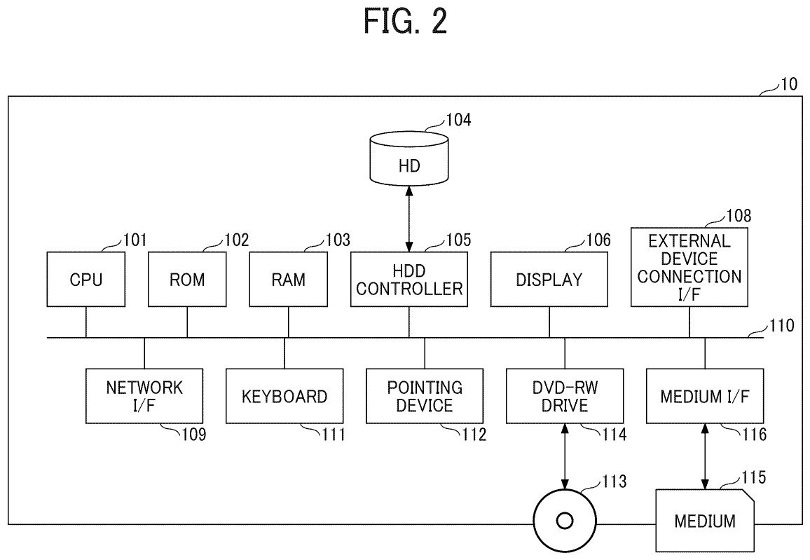

FIG. 2 is a diagram illustrating an example of a hardware configuration of the information processing apparatus 10 according to the first embodiment. As illustrated in FIG. 2, the information processing apparatus 10 is implemented by a computer and includes, for example, a central processing unit (CPU) 101, a read-only memory (ROM) 102, a random-access memory (RAM) 103, a hard disk (HD) 104, a HD drive (HDD) controller 105, a display 106, an external device connection interface (I/F) 108, a network I/F 109, a data bus 110, a keyboard 111, a pointing device 112, a digital versatile disc rewritable (DVD-RW) drive 114, and a medium I/F 116.

The CPU 101 controls the overall operation of the information processing apparatus 10. The ROM 102 stores a program executed by the CPU 101 such as an initial program loader (IPL). The RAM 103 is used as a work area for the CPU 101. The HD 104 stores various data such as a program. The HDD controller 105 controls reading or writing of various types of information from or to the CPU 101 under the control of the HD 104. The display 106 displays various types of information such as a cursor, a menu, a window, characters, or images. The external device connection I/F 108 is an interface circuit that connects with various external devices. Examples of the external devices include, but are not limited to, a universal serial bus (USB) memory and a printer. The network I/F 109 is an interface circuit for communicating with a communication network 100. The data bus 110 is, e.g., an address bus or a data bus for electrically connecting the components such as the CPU 101 illustrated in FIG. 2.

The keyboard 111 is an example of an input device provided with a plurality of keys for allowing a user to enter characters, numerical values, or various instructions. The pointing device 112 is another example of the input device that allows the user to select or execute a specific instruction, select a target for processing, or move a cursor being displayed. The DVD-RW drive 114 reads and writes various data from and to a DVD-RW 113, which is an example of a removable storage medium. The removable storage medium is not limited to the DVD-RW and may be a digital versatile disc-recordable (DVD-R), for example. The medium I/F 116 controls reading and writing (storing) of data from and to a storage medium 115 such as a flash memory.

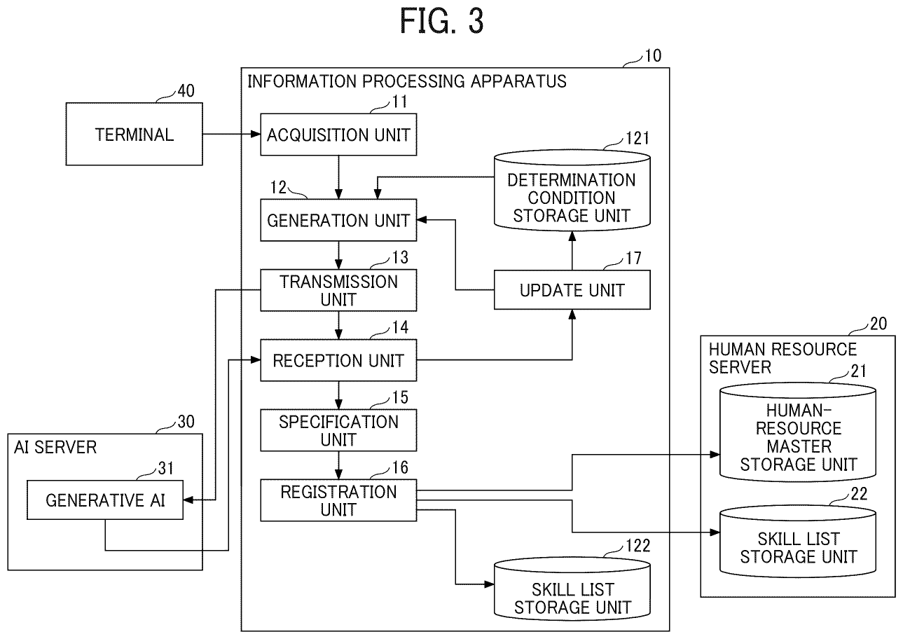

FIG. 3 is a diagram illustrating a functional configuration of the information processing system according to the first embodiment. In FIG. 3, the AI server 30 has a generative AI 31. The generative AI refers to, e.g., a machine learning model (e.g., a neural network) that has acquired the capability of generating various contents by machine learning. In the present embodiment, a machine learning model that receives an input of text and generates text corresponding to the input text may be used as the generative AI. One example of such a machine learning model is a large language model (LLM). The LLM is a machine learning model that has learned natural language processing (NLP) using a large amount of text data. The LLM is used in many NLP tasks, such as generation of responses to specific questions, automatic generation of sentences, text summarization, translation, and sentiment analysis. Further, the LLM may be used in various fields such as education, entertainment, customer service, and product development.

Machine learning is a technique that enables a computer to acquire human like learning capabilities. Machine learning refers to a technique where a computer autonomously generates an algorithm based on pre-acquired training data, for tasks such as data identification to apply the algorithm to new data for prediction. Any suitable learning method may be applied in machine learning, such as supervised learning, unsupervised learning, semi-supervised learning, reinforcement learning, deep learning, or a combination of two or more of these methods.

The human resource server 20 includes a human-resource master storage unit 21 and a skill list storage unit 22. Each of these storage units may be implemented by using an auxiliary memory of the human resource server 20 or a storage device that may be connected to the human resource server 20 via a network.

The skill list storage unit 22 stores list information of a plurality of skills defined in advance. The list information of the skills refers to information including a name of a skill for each skill. The skill list storage unit 22 also stores, for each of a plurality of predefined skills, identification information (in the following description, referred to as “employee ID”) of an individual (salesperson) determined to have the skill.

The human-resource master storage unit 21 stores, for each salesperson belonging to the organization X, information indicating the skill determined to be possessed by the salesperson (i.e., identified for the salesperson).

The information processing apparatus 10 includes an acquisition unit 11, a generation unit 12, a transmission unit 13, a reception unit 14, a specification unit 15, a registration unit 16, and an update unit 17. These units are implemented by the CPU 101 that executes processes according to one or more programs installed on the information processing apparatus 10. The information processing apparatus 10 also access a determination condition storage unit 121 and a skill list storage unit 122. These storage units are each implemented by, e.g., the HD 104 or a storage device that can be connected to the information processing apparatus 10 via the network.

The acquisition unit 11 acquires the speech data from the voice data to be uploaded from the terminal 40. The acquisition of the speech data from the voice data may be performed using any desired voice recognition technique. In addition, in a case where the voice data includes speeches of a plurality of speakers, the acquisition unit 11 may acquire only speech data of the target person using any desired speaker separation technique. When collecting the speech of the target person, for example, a bone conduction microphone may be used to prevent surrounding voice from being mixed into the voice data including the speech of the target person. In other words, a bone conduction microphone may be used to prevent speeches of persons other than the target person from being mixed into the voice data including the speech of the target person.

The generation unit 12 generates a first prompt for instructing the generative AI 31 to output information for identifying a skill related to the speech content among a plurality of predefined skills, based on the speech content included in the speech data acquired by the acquisition unit 11. The first prompt includes speech content and information instructing the generative AI 31 to output information for identifying a skill related to the speech content. In other words, the generation unit 12 generates information for instructing the generative AI 31 to output information for identifying a skill related to the speech content. In the first embodiment, the generation unit 12 generates the first prompt with reference to the determination condition storage unit 121. The determination condition storage unit 121 stores, for each of a plurality of predefined skills, a determination condition for determining that the target person has the skill. In the first embodiment, the determination condition for each skill includes one or more terms (in the following description, referred to as “tags”) related to the skill and an acceptance criterion indicating how many or more of such terms need to be included in the speech data to determine that the target person has the skill. In the determination condition, information indicating a correspondence between a skill and a set of one or more tags is referred to as “correspondence information” in the following description. The generation unit 12 generates, as a first prompt, a prompt for instructing to extract, from a set of tags included in the correspondence information, a tag including a word having the same or similar meaning as that of the tag in the speech data. In other words, the generation unit 12 generates, as a first prompt, a prompt for instructing to extract, from a set of tags related to any of the skills, a tag including a word having the same or similar meaning as that of the tag in the speech data. A word having the same meaning as a certain tag or a word having a meaning similar to a certain tag refers to a character string that is the same as the tag, or a word that is different from the tag in terms of a character string but has the same or similar meaning. A criterion for determining semantic identity and similarity depends on the generative AI 31.

The transmission unit 13 transmits the prompt (e.g., the first prompt) generated by the generation unit 12 to the generative AI 31. As a result, the speech content and information for instructing the generative AI 31 to output information for identifying a skill related to the speech content is transmitted to the generative AI 31.

The reception unit 14 receives a response to the first prompt from the generative AI. The response to the first prompt is referred to as a “first response” in the following description.

The specification unit 15 identifies one or more skills each identified based on the information for identifying a skill included in the first response among the plurality of skills. In the present embodiment, the specification unit 15 is an example of an identifying unit.

The registration unit 16 registers the one or more skills identified by the specification unit 15 and the target person in a first storage unit in association with each other. More specifically, the registration unit 16 registers skill identification information (a skill ID, in the following description) for identifying one or more skills and target person identification information (a target person ID, in the following description) for identifying a target person in the first storage unit in association with each other. In the present embodiment, the skill list storage unit 122, the skill list storage unit 22, and the human-resource master storage unit 21 are examples of the first storage unit. The skill list storage unit 122 stores the same information as that of the skill list storage unit 22 in synchronization. The information processing apparatus 10 includes the skill list storage unit 122, e.g., so that the determination of whether the skill identified by the specification unit 15 has already been registered for the target person can be performed at high speed (compared to the case of inquiring the human resource server 20). This is because it is not necessary to register the previously-registered skill.

The update unit 17 updates the correspondence information stored in the determination condition storage unit 121. More specifically, the update unit 17 updates the list of tags corresponding to each skill. This is because a term related to a certain skill may change with the passage of time. The correspondence information is updated using the generative AI 31. In this case, the generation unit 12 generates a second prompt for instructing generation of one or more tags related to each of a plurality of predefined skills based on one or more pieces of document information related to the plurality of skills (in the following description, referred to as “source document information”) and the correspondence information. The transmission unit 13 transmits the second prompt to the generative AI 31, and the reception unit 14 receives a second response from the generative AI 31 that has received the second prompt. The update unit 17 updates the correspondence information for each of the plurality of skills based on the one or more terms included in the second response. In the present exemplary embodiment, the correspondence information is an example of information for identifying a skill.

The source document information is, e.g., the latest company's-own product information (new product information, scrapped product information, and renewal product information), sales strategy information (target customer information, sales target information, and branding information), and latest trend information in the business field of the organization X for the organization X.

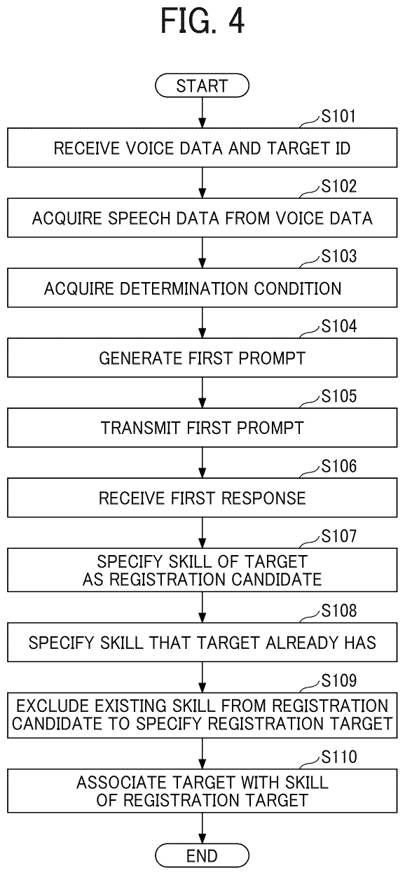

In the following description, a process executed by the information processing system will be described. FIG. 4 is a flowchart of a process of specifying a skill of a target person, according to the first embodiment.

In step S101, the acquisition unit 11 receives the voice data and the employee ID of the target person (in the following description, referred to as “target person ID”) transmitted from the terminal 40. The transmission of the voice data and the target person ID from the terminal 40 may be performed, e.g., at any timing after the voice data is recorded, or while the target person is speaking (in real time).

In step S102, the acquisition unit 11 acquires text format speech data from the received voice data. For example, the speech data may be acquired by applying speech recognition to the voice data.

In step S103, the generation unit 12 acquires a determination condition from the determination condition storage unit 121.

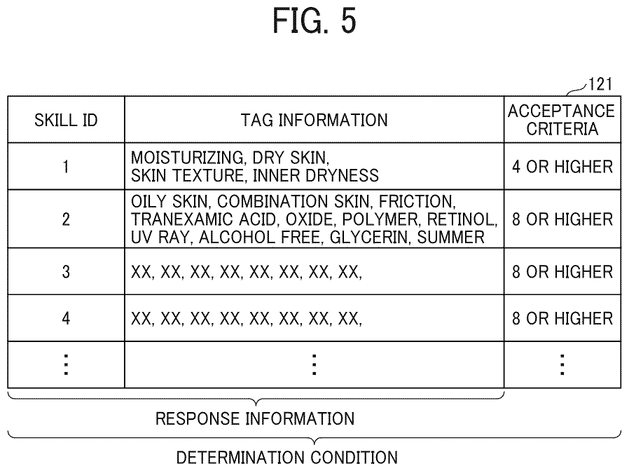

FIG. 5 is a diagram illustrating a configuration of the determination condition storage unit 121 according to the first embodiment. As illustrated in FIG. 5, the determination condition storage unit 121 stores a determination condition including a skill ID, tag information, and an acceptance criterion for each predefined skill. The determination condition is a condition related to the content of the speech that defines a criterion for assuming that the target person whose skill is to be determined has the skill. The determination condition storage unit 121 is an example of a second storage unit.

The skill ID is identification information of a skill. The definition (meaning) of the skill corresponding to the skill ID is stored in the skill list storage unit 122 and the skill list storage unit 22 as described later.

The tag information is a list of tags (terms) related to the skill related to the skill ID. A tag related to a skill may also be a term that is likely to be spoken by a person having the skill. The correspondence between the skill ID and the tag information in the determination condition is an example of correspondence information.

The acceptance criterion is a condition related to the speech content for determining that the user has the skill related to the skill ID. The condition is set based on the number of tags (the number of different types) included in the speech data. For a skill of “N or more,” a condition for determining that the user has the skill is that N or more types of tags in the list of tags corresponding to the skill are included in the speech data.

In step S104, the generation unit 12 generates, as the first prompt, a prompt for instructing to extract, from a set of tags included in the correspondence information each being used as the determination condition, a tag including a word having a meaning identical or similar to the meaning of the word in the speech data. In other words, the generation unit 12 generates, as the first prompt, a prompt for instructing to extract the tag from a set of tags related to any of the skills. The set of tags included in the correspondence information refers to a set of all tags stored in the column of the tag information of the determination condition storage unit 121 (illustrated in FIG. 5), and is an example of information for identifying a skill. For example, the content of the first prompt may be the following.
<Start of Example of First Prompt>

The following is speech data.
[Speech Data]

The following is a set of tags.
[Tag Information]

Extract tags each including a word having the same or similar meanings with that of a word in the speech data from a set of tags and output the tags.
<End of Example of First Prompt>

In the above, the [speech data] is the entire text of the speech data. The [tag information] is a list of all tags included in the tag information of the correspondence information. According to the first prompt as described above, “a tag including a word having the same or similar meaning with a word in the speech data” is indicated. Accordingly, even when the word is not a word that completely matches a certain tag as a character string, the tag is an extraction target as long as a word having the same or similar meaning as that of the tag is included in the speech data.

In step S105, the transmission unit 13 transmits the first prompt generated by the generation unit 12 to the generative AI 31. When the first prompt is input to the generative AI 31, the generative AI 31 outputs a text corresponding to the first prompt based on the learned parameter, and transmits a first response including the text to the information processing apparatus 10.

In S106, the reception unit 14 receives the first response.

In S107, the specification unit 15 specifies a skill ID to be a candidate to be registered for the target person based on the first response and the determination condition (illustrated in FIG. 5). Specifically, the specification unit 15 determines, for each skill ID, whether a set of tags included in the first response satisfies the acceptance criterion set in the determination condition (illustrated in FIG. 5) for the skill ID. For example, for the skill with the skill ID “1” (illustrated in FIG. 5) (in the following description, referred to as “skill 1,” and other skills are identified by the same naming rule), the specification unit 15 determines that the target person has the skill 1 when four or more tags among moisturizing, dry skin, texture, and inner dry are included in the first response. The specification unit 15 identifies the skill ID of the skill of the target person by performing such determination for all the skills. In other words, the specification unit 15 identifies the skill of the target person based on the information for identifying the skill.

In step S108, the registration unit 16 refers to the skill list storage unit 122 to identify a skill that has already been registered for the target person.

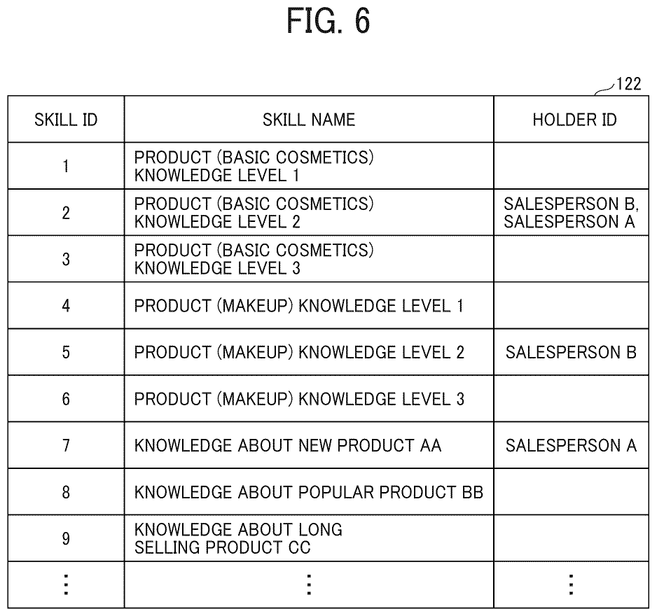

FIG. 6 is a diagram illustrating a configuration of the skill list storage unit 122 according to the first embodiment.

As illustrated in FIG. 6, the skill list storage unit 122 stores a skill ID, a skill name, and a holder ID for each of predefined skills.

The skill ID is identification information of a skill. A skill ID assigned to a certain skill in the skill list storage unit 122 is the same as a skill ID stored in the determination condition storage unit 121 (illustrated in FIG. 5) for the skill.

The skill name is a name of a skill. The name of the skill may be a character string that represents the content of the skill, or may be a simplified name as long as it is capable of identifying the skill.

The holder ID is an employee ID of a salesperson who is determined to have the skill related to the skill ID.

The skill list storage unit 22 also has the same configuration as the configuration illustrated in FIG. 6, and stores the same data as that of the skill list storage unit 122.

The registration unit 16 specifies a skill already registered for the target person (in the following description, referred to as an “existing skill”) by specifying a skill ID for which the target person ID is recorded in the holder ID. However, there may be a case where there is no existing skill, such as a case where the process of FIG. 4 is executed for the first time for the target person.

In step S109, the registration unit 16 specifies a set of skill IDs of the skills to be registered by excluding the skill IDs of the existing skills from a set of the skills to be registered of the target person (a set of the skill IDs specified (identified) by the specification unit 15).

In step S110, the registration unit 16 executes a registering process for associating the target person with a set of skill IDs to be registered. Specifically, the registration unit 16 adds the target person ID to the column of “holder ID” of the record corresponding to the skill ID of the registration target in the skill list storage unit 122 and the skill list storage unit 22. The registration unit 16 also updates the human-resource master storage unit 21.

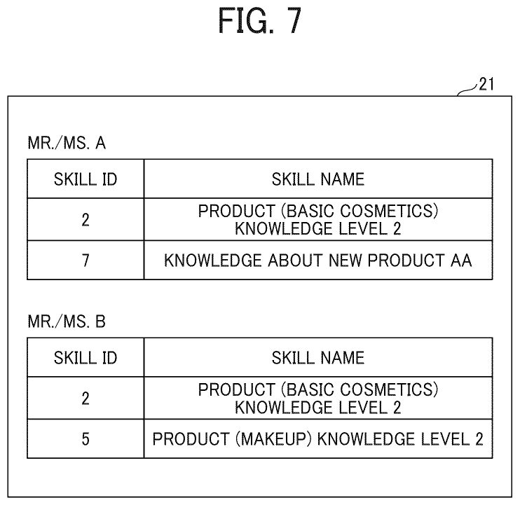

FIG. 7 is a diagram illustrating a configuration of the human-resource master storage unit 21 according to the first embodiment. As illustrated in FIG. 7, the human-resource master storage unit 21 stores, for each salesperson (individual) belonging to the organization X, skill information including the skill ID and the skill name of each skill determined to be possessed by the salesperson.

The registration unit 16 registers the skill ID and the skill name of the registration target skill in the human-resource master storage unit 21 in association with the target person ID.

The update of the correspondence information used as the determination condition (illustrated in FIG. 5) will be described.

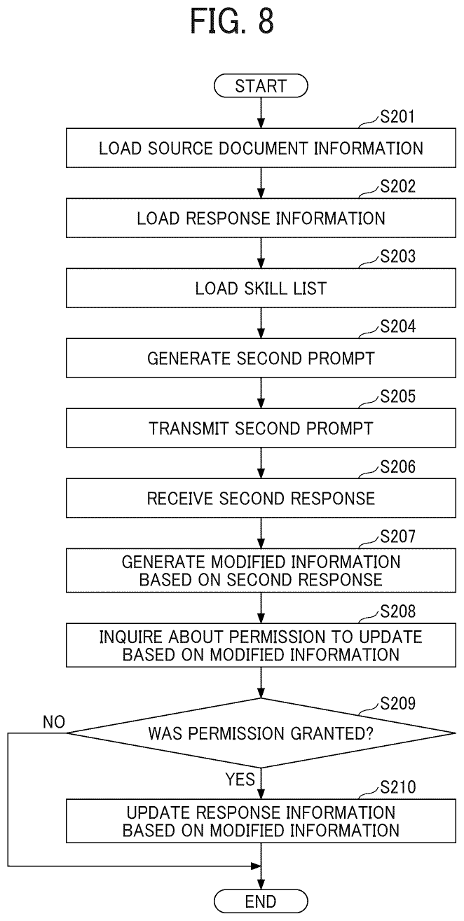

FIG. 8 is a flowchart of a process of updating correspondence information according to the first embodiment. The process of FIG. 8 is executed, e.g., at regular intervals. The regular intervals may be, e.g., a period of time in which a term in the business field of the organization X may change. Alternatively, the process of FIG. 8 may be executed in accordance with an input by a user. The user may be one of the salespeople or a specific employee (e.g., an administrator of the information processing system) in the organization X.

In step S201, the generation unit 12 reads the source document information in response to the request for generating the second prompt from the update unit 17. The contents of the source document information are as described above.

The source document information may be stored in advance in, e.g., the HD 104.

In step S202, the generation unit 12 reads correspondence information of all determination conditions from the determination condition storage unit 121 (illustrated in FIG. 5).

In step S203, the generation unit 12 reads the skill name corresponding to each skill ID from the skill list storage unit 122 (illustrated in FIG. 6).

In step S204, the generation unit 12 generates a second prompt based on the information read in steps S201 to S203. For example, the content of the second prompt may be as follows.
<Start of Example of Second Prompt>

Currently, the correspondence between each skill and a term is defined as follows.
[List of Correspondences between Skill Names and Tag Information]

On the other hand, information for reviewing the correspondence is as follows.
[Source Document Information]

Based on this information, please review the above correspondence. When there is a skill whose correspondence should be changed, output correspondence information between the skill name and the term.
<End of Example of Second Prompt>

In the above description, the list of correspondences between skill names and tag information is text indicating, for each skill, a correspondence between a skill name and tag information (a list of tags) corresponding to the skill.

Such a text can be generated based on the correspondence between the skill ID and the tag information in the correspondence information (illustrated in FIG. 5) and the skill name corresponding to each skill ID acquired from the skill list storage unit (illustrated in FIG. 6). The source document information is, e.g., text indicating the entire text of the extraction source document information.

In step S205, the transmission unit 13 transmits the second prompt generated by the generation unit 12 to the generative AI 31. When the second prompt is input to the generative AI 31, the generative AI 31 outputs a text corresponding to the second prompt based on the learned parameter, and transmits a second response including the text to the information processing apparatus 10.

In step S206, the reception unit 14 receives the second response.

In step S207, the update unit 17 generates new correspondence information (in the following description, referred to as “changed correspondence information”) by changing the correspondence information stored in the determination condition storage unit 121 (illustrated in FIG. 5) based on the second response. Specifically, according to the second prompt exemplified above, the skill name of the skill whose tag information has been changed and the tag information after the change are included in the second response. For example, the update unit 17 generates, as the change information, information (a set of the skill ID, the current tag information, and the changed tag information) including the skill ID corresponding to the skill name included in the second response, the tag information (in the following description, referred to as “current tag information”) in the current correspondence information related to the skill ID, and the tag information (in the following description, referred to as “changed tag information”) acquired by changing the current tag information based on the tag information (in the following description, referred to as “new tag information”) included for the skill name in the second response. The change information is generated for each skill name included in the second response.

For example, the changed tag information may be a result of adding, to the current tag information, a tag that is not included in the current tag information among the tags included in the new tag information. Alternatively, the changed tag information may be a result of deleting, from the current tag information, a tag that is not included in the new tag information among the tags included in the current tag information. Alternatively, the new tag information may be used as the changed tag information as it is.

In step S208, the update unit 17 inquires of a user such as an administrator whether to permit the current tag information to be updated to the changed tag information. For example, the update unit 17 transmits information for inquiring about the permission or refusal (in the following description, referred to as “inquiry information”) to the terminal 40 of the user. The inquiry information may be information for inquiring whether to collectively permit all the change information, or may be information for inquiring whether to permit the current tag information to be updated to the changed tag information for each change information. The terminal 40 of the user displays a screen for inquiring about the permission or refusal based on the information. When the user inputs permission or refusal of the update via the screen, the terminal 40 transmits the input result by the user to the update unit 17. At this time, when it is possible to select whether to permit the update for each piece of change information, the terminal 40 may transmit the current tag information for which the update is permitted by the user to the update unit 17.

In step S210, the update unit 17 updates (replaces) the current tag information included in the change information with the changed tag information included in the change information in the determination condition storage unit 121, when there is change information for which permission of update is input by the user (Yes in step S209). When no input indicating permission of update is performed for any change information (No in step S209), the current tag information is not updated.

The update unit 17 may forcibly execute the step S210 instead of executing the step S208 and the step S209. In other words, the update unit 17 may update the current tag information to the changed tag information instead of inquiring of the user whether to permit the update.

As described above, according to the first embodiment, the skill of the target person can be specified using the generative AI 31 based on the speech data of the target person. The speech data is data indicating the speech content of the target person in a natural language. Accordingly, a skill can be registered using the generative AI from a natural language input by, e.g., speech.

It is also conceivable to cause the target person to self-declare the skill possessed by the target person, using, e.g., a personal history. However, even when the target person is self-declared to have a certain skill, it is unclear whether the level of the skill is the level required by the evaluator (organization X). In the present embodiment, since the skill of the target person is specified based on the actual speech content of the target person, the possibility of specifying the skill can be enhanced more accurately than the self-declaration depending on the definition of the determination condition, and the workload of the party can be reduced.

A second embodiment is described below. In the second embodiment, differences from the first embodiment are described. Accordingly, elements, members, components, or operations of which description are omitted below may be substantially the same as those of the first embodiment.

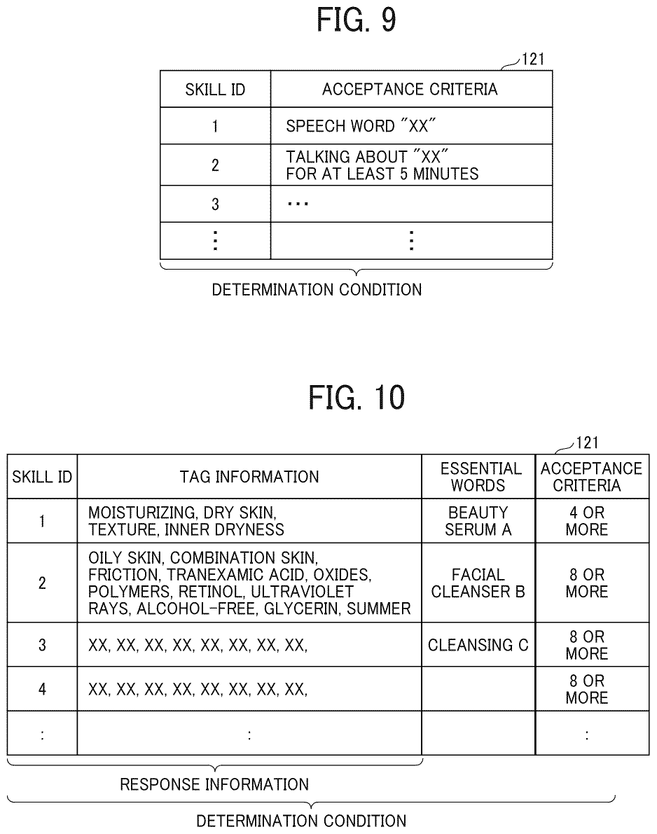

The second embodiment is different from the first embodiment in the configuration of the determination condition storage unit 121. FIG. 9 is a diagram illustrating a configuration of the determination condition storage unit 121 according to the second embodiment.

As illustrated in FIG. 9, the determination condition storage unit 121 according to the second embodiment stores a determination condition in which a skill ID and an acceptance criterion are associated with each other for each predefined skill.

That is, the determination condition according to the second embodiment does not include the tag information. Therefore, in the second embodiment, the acceptance criterion is not based on the tag information, and the condition related to the speech content for determining that the user has the skill related to the skill ID is set in a free form. The free format may be any format as long as the content of the generative AI 31 is understandable. In the second embodiment, the skill ID is an example of information for identifying a skill.

In the second embodiment, the flow of the registration processing of the skill of the target person is the same as that in FIG. 4. However, in step S103, the generation unit 12 acquires the determination condition as illustrated in FIG. 9. In step S104, the generation unit 12 generates, as a first prompt, a prompt for instructing to output information for identifying a skill related to the speech content based on the acceptance criterion for each skill and the speech content included in the speech data. Specifically, in step S104, the generation unit 12 generates, as the first prompt, a prompt for instructing extraction of a skill ID related to a determination condition in which the speech content satisfies the acceptance criterion among the acquired determination conditions. For example, the content of the first prompt may be following.
<Start of Example of First Prompt>

The following is speech data.
[Speech Data]

The following is a list of determination conditions including a skill ID and an acceptance criterion.
[List of Determination Conditions]

Extract and output the skill ID of the determination condition in which the speech data satisfies the acceptance criterion from the list of the determination conditions.
<End of Example of First Prompt>

In the above description, the list of determination conditions is a text indicating a list of sets of skill IDs and acceptance criteria.

In step S105, the transmission unit 13 transmits the first prompt generated by the generation unit 12 to the generative AI 31. When the first prompt is input to the generative AI 31, the generative AI 31 outputs a text corresponding to the first prompt based on the learned parameter, and transmits a first response including the text to the information processing apparatus 10.

In step S106, the reception unit 14 receives the first response. In the second embodiment, the first response includes the skill ID of the skill determined to be possessed by the target person. In other words, in the second embodiment, the generative AI 31 executes up to the specification of the skill of the target person. Accordingly, in step S107, the specification unit 15 specifies the skill (skill ID) included in the second response as the skill possessed by the target person. The step S108 and subsequent steps may be the same as those in the first embodiment. In other words, the specification unit 15 identifies the skill of the target person based on the information for identifying the skill.

Since the determination condition according to the second embodiment does not include the correspondence information (association between the skill and the tag information), the correspondence information may not be updated. Therefore, the information processing apparatus 10 according to the second embodiment may not include the update unit 17.

As described above, according to the second embodiment, the skill of the target person can be specified by the determination condition different from the condition of the first embodiment. Since the determination condition according to the second embodiment has a less strict structural restriction than the determination condition according to the first embodiment, a determination condition having a relatively high degree of freedom can be set.

A third embodiment is described below. In the third embodiment, differences from the first embodiment are described. Accordingly, elements, members, components, or operations of which description are omitted below may be substantially the same as those of the first embodiment.

The third embodiment is different from the first embodiment in the configuration of the determination condition storage unit 121. FIG. 10 is a diagram illustrating a configuration of the determination condition storage unit 121 according to the third embodiment.

As illustrated in FIG. 10, the determination condition storage unit 121 according to the third embodiment further stores a determination condition including an essential word for each predefined skill.

The essential word for a certain skill refers to a keyword (character string) that is required to be included in the speech data in order to determine that the target person has the skill. The essential word may be any one of the tag information, or may be a term different from the tag information.

In the third embodiment, the flow of the registration processing of the skill of the target person is the same as that in FIG. 4. However, in step S103, the generation unit 12 acquires the determination condition as illustrated in FIG. 9. In step S104, the generation unit 12 generates, as a first prompt, a prompt for instructing to extract, from a set of tags included in the correspondence information each used as the determination condition, a tag that corresponds to a skill related to an essential word included in the speech data and that includes a word having a common meaning as a word in the speech data. For example, the content of the first prompt may be following.
<Start of Example of First Prompt>

The following is speech data.
[Speech Data]

The following is the correspondence between the essential words and the tag sets.
[Essential Word and Tag Information for Each Skill]

Extract a tag corresponding to an essential word included in the speech data and including a word having the same or similar meaning to a word in the speech data from a set of tags, and output the tag.
<End of Example of First Prompt>

In the above description, the essential word and tag information for each skill is a text indicating a list of sets of a skill ID, an essential word, and tag information.

The step S105 and subsequent steps are the same as those in the first embodiment.

As described above, according to the third embodiment, in order to determine whether the target person has a certain skill, inclusion of a specific keyword in the speech data is a requirement. When the requirement is satisfied, it is determined whether the target person has the skill based on the tag information and the acceptance criterion. For example, in the case of the skill 1 illustrated in FIG. 10, when “beauty serum” is included in the speech data, the determination is performed based on the tag information and the acceptance criterion. Accordingly, setting a term related to a specific field as an essential word can avoid an erroneous determination that the user has a skill in the specific field based on speech data related to another field.

A fourth embodiment is described below. In the fourth embodiment, differences from the above embodiments will be described. Accordingly, the points not particularly mentioned may be the same as those in the above embodiments.

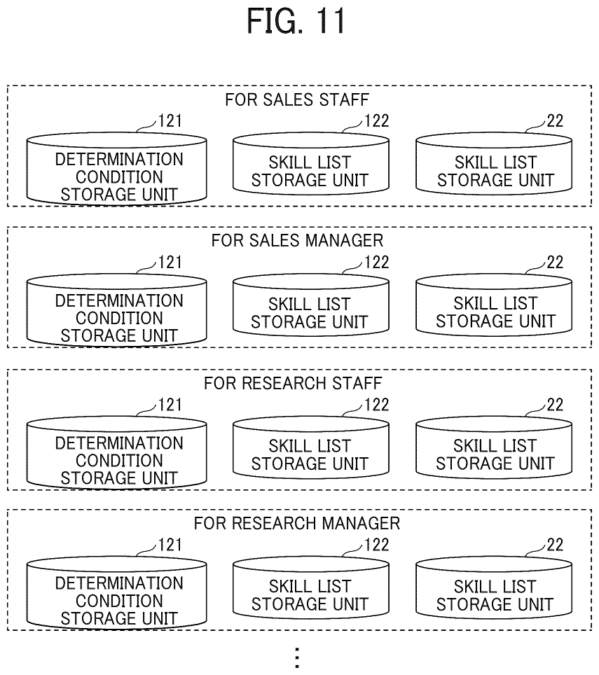

FIG. 11 is a diagram illustrating the fourth embodiment. In the fourth embodiment, the determination condition storage unit 121, the skill list storage unit 122, and the skill list storage unit 22 (in other words, a plurality of skills and correspondence information) are defined (prepared) for each attribute of an individual (salesperson) who is a skill evaluation target. In other words, a plurality of skills and correspondence information are defined (prepared) for each attribute of an individual (salesperson) who is a skill evaluation target. The attributes may be classified (distinguished) by, e.g., job type, role (part or position) or may be classified by other criteria that may require different skills. In FIG. 11, an example is illustrated in which, in a case where the attributes are, e.g., a person in charge of a sales job, a manager of a sales job, a person in charge of a career in research, and a manager of a career in research, the determination condition storage unit 121, the skill list storage unit 122, and the skill list storage unit 22 are defined (prepared) for each of these attributes.

The attribute to which each individual belongs may be stored in, e.g., the human-resource master storage unit 21 in association with the employee ID. The generation unit 12 and the specification unit 15 may use the determination condition storage unit 121 corresponding to the attribute to which the target person belongs. The registration unit 16 may register the skill list storage unit 122 and the skill list storage unit 22 corresponding to the attribute to which the target person belongs.

As described above, according to the fourth embodiment, e.g., in a case where the meanings of terms used in a determination condition are different depending on, e.g., the job type even when the terms are the same, the skill of the target person can be more accurately specified.

A fifth embodiment is described below. In the fifth embodiment, differences from the first embodiment are described. Accordingly, elements, members, components, or operations of which description are omitted below may be substantially the same as those of the first embodiment.

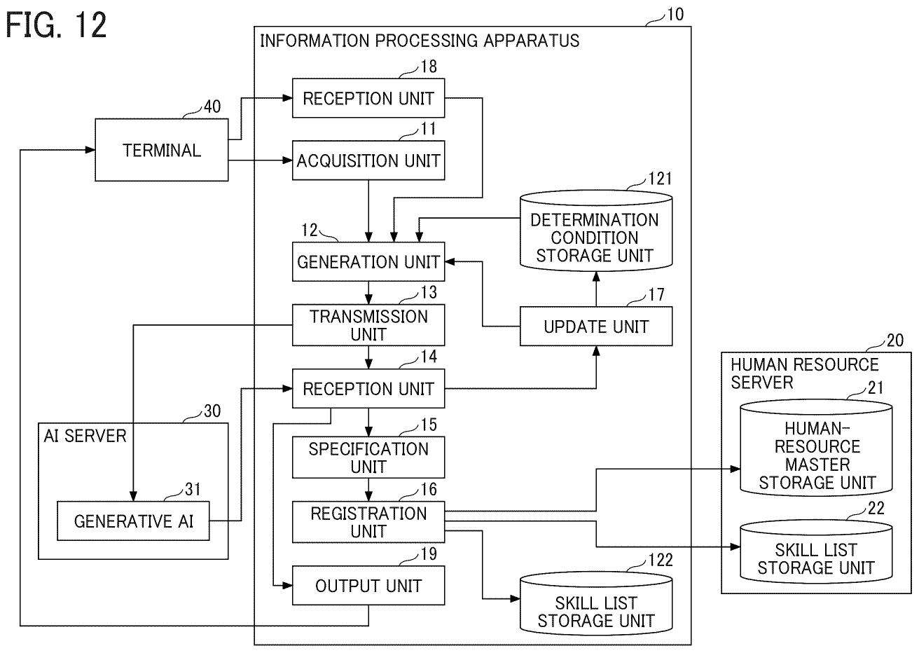

FIG. 12 is a diagram illustrating a functional configuration of the information processing system according to the fifth embodiment.

In FIG. 12, the same elements as those in FIG. 3 are denoted by the identical or similar reference signs, and descriptions thereof will be omitted.

In FIG. 12, the information processing apparatus 10 further includes a reception unit 18 and an output unit 19. These units are implemented by the CPU 101 that executes processes according to one or more programs installed on the information processing apparatus 10.

The reception unit 18 receives a search condition described in a natural language.

The output unit 19 outputs the list information of the salesperson matched with the search conditions. In the following description, the search process for a salesperson who matches the search condition is referred to as a “human resource search process.”

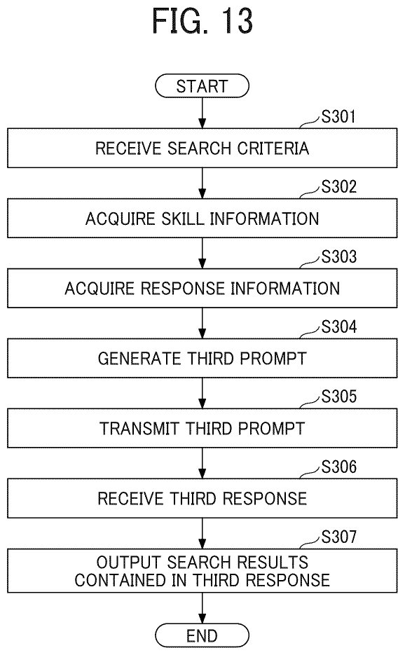

FIG. 13 is a flowchart of a human-resource search process according to the fifth embodiment.

In step S301, the reception unit 18 receives the search condition input in the terminal 40 from the terminal 40. The reception unit 18 requests the generation unit 12 to generate a third prompt for causing the generative AI 31 to execute a search based on the search condition.

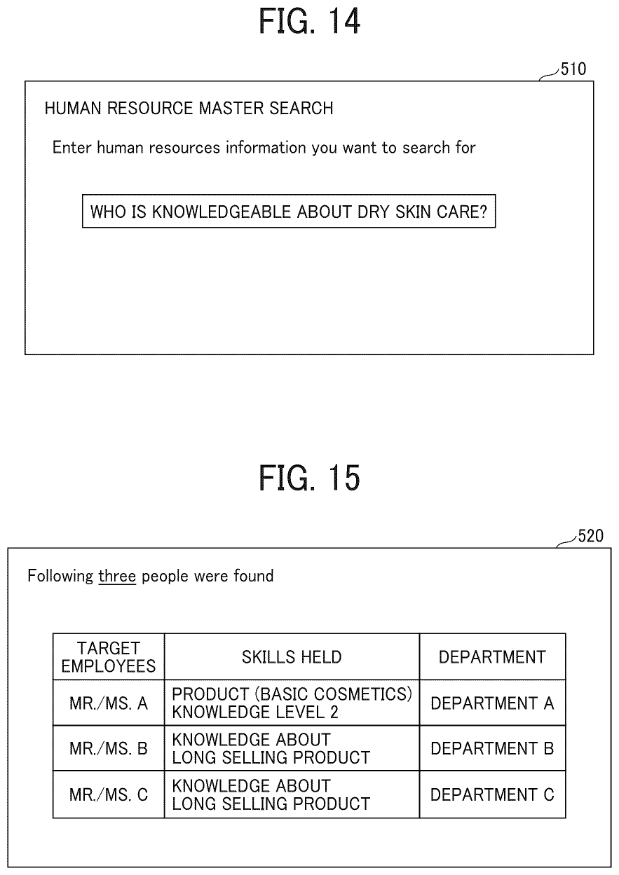

In the terminal 40, e.g., a search condition described in a natural language may be input via a search condition input screen 510 as illustrated in FIG. 14. In FIG. 14, an example is illustrated in which a search condition such as “Who is knowledgeable about dry skin care?” is input.

The generation unit 12 executes a process for generating the third prompt in response to a request from the reception unit 18. In step S302, the generation unit 12 acquires skill information for each salesperson from the human-resource master storage unit 21 (illustrated in FIG. 7). In step S303, the generation unit 12 acquires the correspondence information (the skill ID and the tag information) included in each determination condition from the determination condition storage unit 121 (illustrated in FIG. 5). In step S304, the generation unit 12 generates a prompt for instructing search of a person (salesperson) associated with a skill matching the search condition as a third prompt based on the search condition, the skill information, and the correspondence information received by the reception unit 18. For example, the content of the third prompt may be as follows.
<Start of Example of Third Prompt>

The skills that each salesperson currently has are as follows.
[Skill Information for Each Salesperson]

The terms related to each skill ID are as follows.
[Correspondence Information]

On the premise of the above, extract and output salespeople having skills that match the following search conditions.
[Search Condition]
<End of Example of Third Prompt>

In the above description, skill information for each salesperson is a text indicating the skill information (the employee ID, the skill ID, and the skill name) acquired in the step S302 for each salesperson. The correspondence information is a text indicating the correspondence information acquired in the step S303. The search condition is a text indicating a search condition.

In step S305, the transmission unit 13 transmits the third prompt generated by the generation unit 12 to the generative AI 31. When the third prompt is input to the generative AI 31, the generative AI 31 outputs a text corresponding to the third prompt based on the learned parameter, and transmits a third response including the text to the information processing apparatus 10.

In step S306, the reception unit 14 receives the third response.

In step S307, the output unit 19 outputs (transmits) the search result (i.e., the list information of the employee IDs matching the search condition) included in the third response to the terminal 40 being the transmission source of the search condition. In other words, the output unit 19 outputs (transmits) the list information of the employee IDs matching the search condition included in the third response to the terminal 40 being the transmission source of the search condition. For example, the output unit 19 may cause the terminal 40 to display a search result screen 520 as illustrated in FIG. 15.

As described above, according to the fifth embodiment, the user can specify a human resource having a predetermined skill by inputting the human resource in a natural language. As a result, for example, when human-resource assignment (assignment of salespersons to stores) or human-resource transfer is performed, salespersons having predetermined skills can be assigned to stores in a distributed manner.

The fifth embodiment may be combined with the third embodiment or the fourth embodiment.

A sixth embodiment is described below. In the sixth embodiment, differences from the first embodiment are described. Accordingly, elements, members, components, or operations of which description are omitted below may be substantially the same as those of the first embodiment.

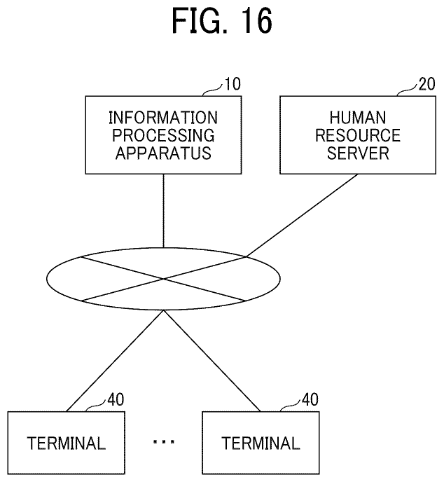

FIG. 16 is a diagram illustrating a configuration of an information processing system according to the sixth embodiment. In FIG. 16, the identical or similar reference signs are given to the same or corresponding parts as those in FIG. 1, and the description thereof will be omitted.

As illustrated in FIG. 16, the information processing system according to the sixth embodiment may not include the AI server 30.

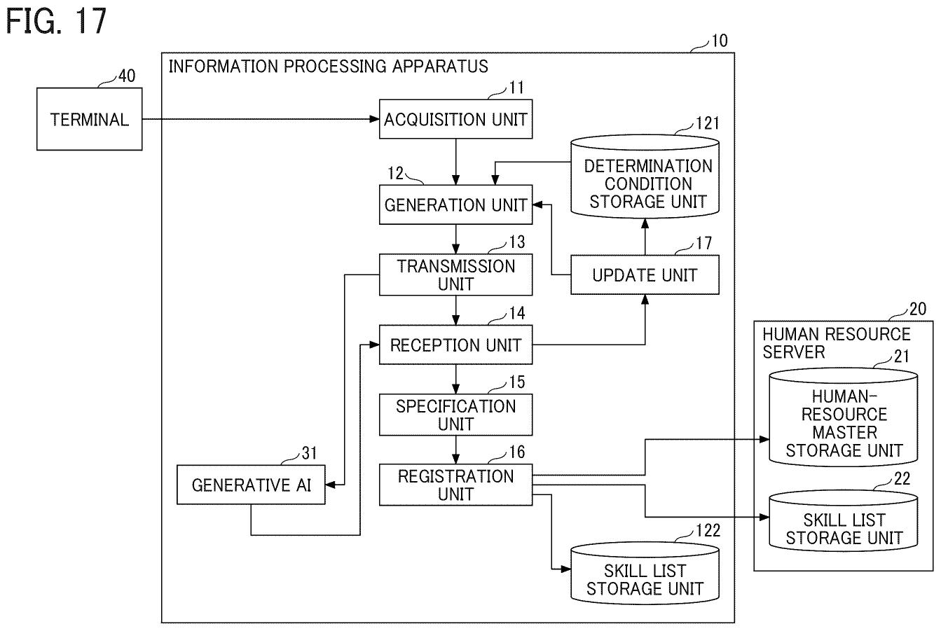

FIG. 17 is a diagram illustrating an example of a functional configuration of the information processing system according to the sixth embodiment.

In FIG. 17, the same elements as those in FIG. 3 are denoted by the identical or similar reference signs, and descriptions thereof will be omitted.

In FIG. 17, the information processing apparatus 10 further includes a generative AI 31. In other words, in the sixth embodiment, the generative AI 31 is present inside the information processing apparatus 10, not outside the information processing apparatus 10. Accordingly, in the sixth embodiment, the external AI server 30 may not exist.

The processing executed in the sixth embodiment may be the same as that in the first embodiment.

The sixth embodiment may be combined with one or more of the second to fifth embodiments.

A seventh embodiment is described below. In the seventh embodiment, differences from the first embodiment are described. Accordingly, elements, members, components, or operations of which description are omitted below may be substantially the same as those of the first embodiment.

In the seventh embodiment, an example in which the generative AI 31 is multimodal AI will be described. For example, although the above embodiments have been described with reference to the case where the speech data is text, the speech data may be voice data and input to the generative AI 31. Alternatively, instead of the voice data, a moving image (including voice) acquired by capturing a state in which the target person is speaking may be used as an input to the generative AI 31 as the speech. The speech data of the target person may not necessarily be data based on the voice spoken by the target person. For example, presentation materials (projected materials) used by the target person for explanation in, e.g., a conference, a conference name, a date and time of the conference, a history of business chatting of the target person, and information of an invitation may be input to the generative AI 31. It is expected that inputting multimodal information to the generative AI 31 can enhance the accuracy of specifying a skill.

When the voice data or the moving image data is input to the generative AI 31, an instruction to output a numerical value indicating the probability (certainty) of the component (tag or skill) included in the text output from the generative AI 31 according to the way of speaking (e.g., the loudness and speed of the voice) by the target person may be included in the prompt to the generative AI 31. Specifically, a relatively high degree of certainty may be given to a tag or a skill extracted from a portion corresponding to a way of speaking in which the content of the speech is likely to be confident in the speech data, and a relatively low degree of certainty may be given to a tag or a skill extracted from a portion other than that. In this case, the human-resource master storage unit 21 (illustrated in FIG. 7) may store, for each salesperson, the probability of each skill determined to be possessed by the salesperson. The user may specify a threshold for the likelihood to identify a salesperson with a certain skill.

An eighth embodiment is described below. In the eighth embodiment, differences from the above embodiments will be described. Accordingly, the points not particularly mentioned may be the same as those in the above embodiments.

Following the step S109 in FIG. 4, the registration unit 16 transmits, to the terminal 40 of the target person, information indicating the skills to be registered that have been specified for the target person and for inquiring of the target person whether the skills need to be registered.

The terminal 40 of the target person displays a screen (in the following description, referred to as a “registration inquiry screen”) for inquiring of the target person whether the target person needs to register the skill, based on the information.

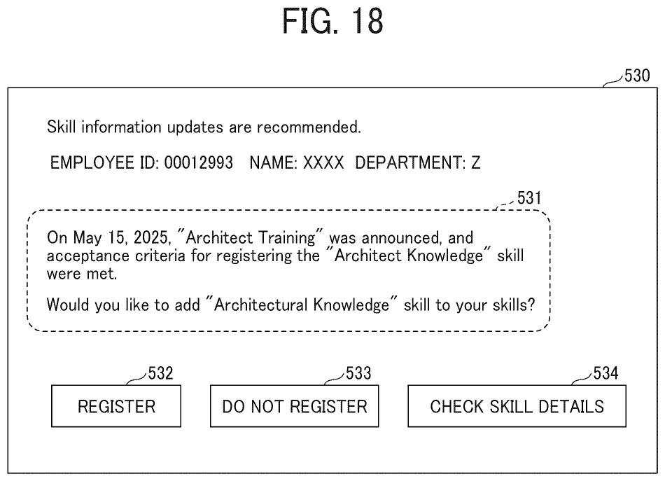

FIG. 18 is a diagram illustrating a display example of a registration inquiry screen according to the eighth embodiment. As illustrated in FIG. 18, the registration inquiry screen 530 includes a message 531 and buttons 532 to 534.

The message 531 includes, e.g., information indicating that there is a new skill that satisfies the acceptance criteria, the name of the skill, and a recommendation to register the skill as a skill possessed by the target person.

The button 532 is a button for receiving an instruction to register the skill.

The button 533 is a button for receiving an instruction not to register the skill.

The button 534 is a button for receiving an instruction to display detailed information of the skill.

When the target person presses any of the buttons 532 to 534, the terminal 40 transmits information corresponding to the pressed button to the registration unit 16. When the information is an instruction to register a skill, the registration unit 16 executes step S110. When the information is an instruction not to register a skill, the registration unit 16 does not execute the step S110. When the information is an instruction to display detailed information of a skill, the registration unit 16 transmits the detailed information regarding the skill to be registered to the terminal 40 of the target person. The detailed information is stored for each skill in, e.g., the skill list storage unit 122 and the skill list storage unit 22.

As described above, according to the eighth embodiment, before the target person is registered as possessing the automatically identified skill, the target person is inquired about whether the registration of the skill is necessary. Therefore, the recognition of the target person (e.g., the awareness of having the skill) can be reflected on the skill list storage unit 122, the skill list storage unit 22, and the human-resource master storage unit 21.

In addition, the user can grasp which skill is registered as the user's own skill.

A ninth embodiment is described below. In the ninth embodiment, differences from the first to seventh embodiments will be described. Accordingly, the points not particularly mentioned may be the same as those in the first to seventh embodiments.

Following the step S110 in FIG. 4, the registration unit 16 reads out, from the skill list storage unit 122, skill update information including a list of skills associated with the target person in the skill list storage unit 122 (skills possessed by the target person) and information indicating skills newly associated with the target person in the step S110 in the list, and history information of the target person, and notifies the terminal 40 of the target person of the skill update information and the history information. The history information of the target person is information indicating a history of business activities (e.g., sales activities) of the target person in the organization X. The history information is stored, e.g., in the human-resource master storage unit 21 for each salesperson belonging to the organization X.

The terminal 40 of the target person displays a screen for notifying the update of the skill possessed by the target person (in the following description, referred to as “possessed-skill update notification screen”) based on the skill information notified from the registration unit 16.

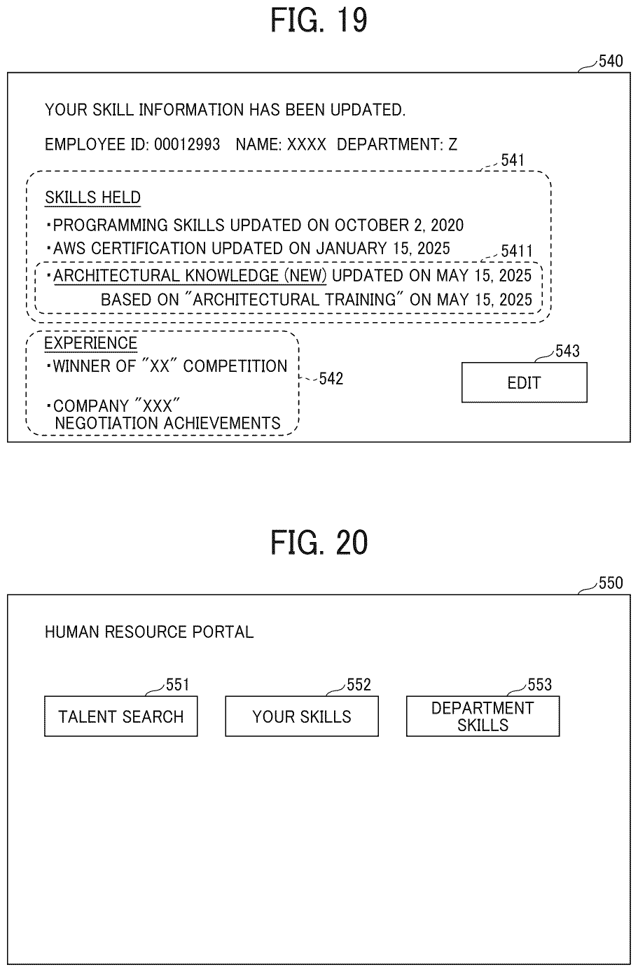

FIG. 19 is a diagram illustrating a display example of a possessed-skill update notification screen according to the ninth embodiment. As illustrated in FIG. 19, the possessed-skill update notification screen 540 includes an area 541, an area 542, and a button 543.

The area 541 is an area including a list of skills in the skill update information. The skills included in the area 5411 of the area 541 correspond to the newly registered skills. The area 542 is an area including the history information of the target person. The button 543 is a button for receiving an instruction to edit the skill possessed by the target person (association between the target person and the skill in the skill list storage unit 122, the skill list storage unit 22, and the human-resource master storage unit 21) or the history information of the target person. When the button 543 is pressed, an editing screen of the possessed skill and the history information is displayed. The target person can edit the possessed skill or the history information via the editing screen.

As described above, according to the ninth embodiment, the target person can be notified that the possessed skill has been automatically updated.

The ninth embodiment may be combined with the eighth embodiment. For example, the possessed-skill update notification screen 540 may be displayed when the button 532 of the registration inquiry screen 530 is pressed. In this case, the possessed-skill update notification screen 540 plays a role of notifying the target person that the possessed skill has been surely updated in accordance with the pressing of the button 532 of the registration inquiry screen 530.

A tenth embodiment is described below. In the tenth embodiment, differences from the fifth embodiment are described. Accordingly, the points not particularly mentioned may be the same as those in the fifth embodiment.

In the tenth embodiment, the terminal 40 displays the human-resource portal screen in response to a predetermined operation by the user before the step S301 in FIG. 13.

FIG. 20 is a diagram illustrating a display example of a human-resource portal screen according to the tenth embodiment. The human-resource portal screen 550 is a screen serving as a portal for a service provided by the information processing apparatus 10, and includes buttons 551 to 553.

For example, the human-resource portal screen 550 is displayed on the terminal 40 in response to the login of the user to the information processing apparatus 10. Accordingly, at the time when the human-resource portal screen 550 is displayed, the employee ID of the user of the terminal 40 (in the following description, referred to as “login user”) is specified by the information processing apparatus 10.

When the button 551 is pressed, the terminal 40 displays a search condition input screen 510 (illustrated in FIG. 14). In this case, the processing procedure described in FIG. 13 is executed in response to the input of the search condition on the search condition input screen 510.

When the button 552 is pressed, the terminal 40 transmits a request to acquire personal information of the login user to the information processing apparatus 10. When the reception unit 18 of the information processing apparatus 10 receives the acquisition request, the output unit 19 acquires the skill list information indicating the list of skills associated with the employee ID of the login user and the history information of the login user from the human-resource master storage unit 21. In the tenth embodiment, the history information of each salesperson belonging to the organization X is stored in the human-resource master storage unit 21. The output unit 19 transmits the skill list information and the history information to the terminal 40. The terminal 40 displays the personal information screen including the skill list information and the history information.

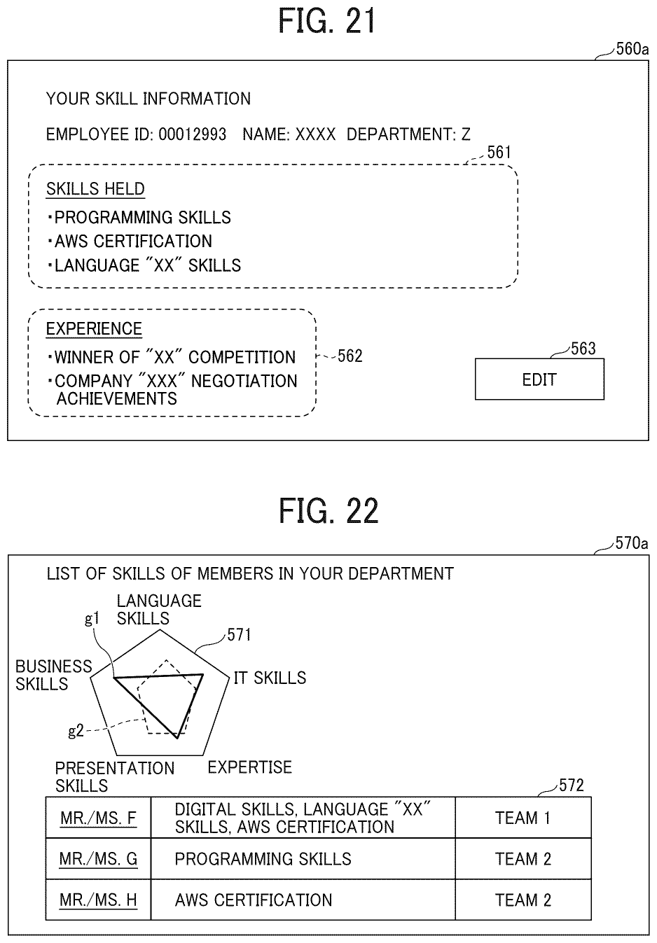

FIG. 21 is a diagram illustrating a display example of a personal information screen according to the tenth embodiment. As illustrated in FIG. 21, the personal information screen 560a includes an area 561, an area 562, and a button 563. The area 561 is an area including the skill list information of the login user. The area 562 is an area including the history information of the login user. The button 563 is a button for receiving an instruction to edit the skills possessed by the login user (association between the login user and the skills in the skill list storage unit 122, the skill list storage unit 22, and the human-resource master storage unit 21) or the history information of the login user. When the button 563 is pressed, an editing screen of the possessed skill and the history information is displayed. The login user can edit the possessed skill or the history information via the editing screen. The edited result is stored in, e.g., the skill list storage unit 122, the skill list storage unit 22, and the human-resource master storage unit 21.

When the button 553 is pressed on the human-resource portal screen 550, the terminal 40 transmits an acquisition request for skill information of a department to which the login user belongs (in the following description, referred to as a “target department”) to the information processing apparatus 10. When the reception unit 18 of the information processing apparatus 10 receives the acquisition request, the output unit 19 acquires, for each salesperson belonging to the target department, skill list information indicating a list of skills associated with the salesperson from the human-resource master storage unit 21. In the tenth embodiment, the human-resource master storage unit 21 stores information indicating the departments and teams to which the respective salespeople belong. A team is a group of employees in a department. Accordingly, by referring to the human-resource master storage unit 21, the target department and each salesperson belonging to the target department can be specified. The output unit 19 transmits the acquired information to the terminal 40. The terminal 40 displays a department information screen including the information.

FIG. 22 is a diagram illustrating a display example of a department information screen according to the tenth embodiment. As illustrated in FIG. 22, the department information screen 570a includes a radar chart 571 and a table 572.

The radar chart 571 is a radar chart in which skill categories are assigned to the respective axes, and a graph g1 corresponding to the target department and a graph g2 corresponding to the entire organization X are drawn. The skill category is a category for a skill stored in the skill list storage unit 122 (illustrated in FIG. 6). One or more skills belong to one skill category.

Information indicating to which skill each skill belongs may be stored in the skill list storage unit 122 or may be stored in another storage unit.

The value of the graph g1 of a certain axis of the radar chart 571 is the ratio of the salespeople who possess the skills belonging to the skill category corresponding to the axis in the target department. Alternatively, for each salesperson belonging to the target department, points for each skill category may be calculated according to the skill of the salesperson, and the average value of the points of each salesperson for each skill category may be set as the value of the graph g1. The value of the graph g2 of a certain axis of the radar chart 571 is the ratio of the salespersons who possess the skills belonging to the skill category corresponding to the axis in the organization X. However, other indices may be assigned to the respective axes of the radar chart 571. The output unit 19 of the information processing apparatus 10 refers to the skill list storage unit 122 (illustrated in FIG. 6), calculates the graph g1 and the values of the axes of the graph g2, and generates the radar chart 571. The output unit 19 transmits the radar chart 571 to the terminal 40 together with the skill list information of each salesperson belonging to the target department.

As a result, the terminal 40 may display the radar chart 571. The items assigned to the axes of the radar chart 571 are not limited to the skill categories. For example, other items such as a female activity rate and an experience value of a business may be assigned.

The table 572 includes the name of each salesperson of the target department, skill list information, and the team to which the salesperson belongs. In the table 572, the name of each salesperson is linked to the personal information of the salesperson.

When the user clicks any one of the names in the table 572, the terminal 40 transmits an acquisition request for personal information including an employee ID of a salesperson (in the following description, referred to as a “target salesperson”) related to the name to the information processing apparatus 10. When the reception unit 18 of the information processing apparatus 10 receives the acquisition request, the output unit 19 acquires the skill list information indicating the list of skills associated with the employee ID and the history information associated with the employee ID from the human-resource master storage unit 21. The output unit 19 transmits the skill list information and the history information to the terminal 40. The terminal 40 displays a personal information screen including the skill list information and the history information.

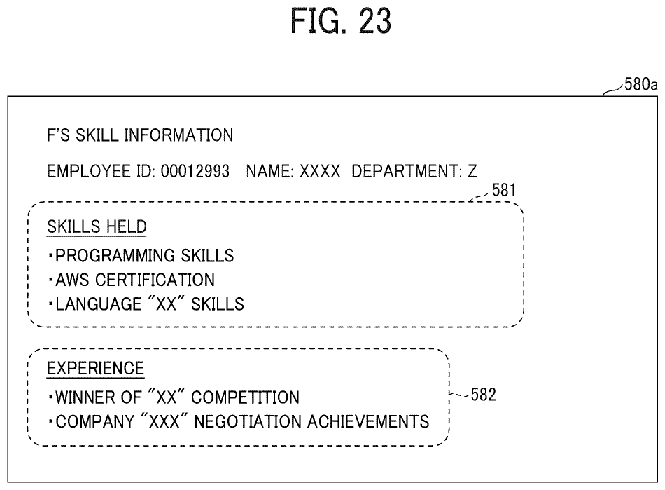

FIG. 23 is a diagram illustrating a display example of a personal information screen according to the tenth embodiment. As illustrated in FIG. 23, the individual information screen 580a includes an area 581 and an area 582. The area 581 is an area including the skill list information of the target salesperson. The area 582 is an area including the history information of the target salesperson.

The user can check, e.g., the skills possessed by the target salesperson by referring to the individual information screen 580a.

In the human-resource portal screen 550 (illustrated in FIG. 20), the button 533 may be enabled to be pressed only by an employee of a managerial position. In this case, the department information screen 570a and the individual information screen 580a can be displayed only when the user is a manager.

As described above, according to the tenth embodiment, for example, the salesperson having a specific skill, the skill information of the person himself/herself, and the skill information of the department can be confirmed from the human-resource portal screen 550 (illustrated in FIG. 20). Accordingly, the operation burden for confirming these pieces of information can be reduced.

An eleventh embodiment is described below. In the eleventh embodiment, differences from the tenth embodiment are described. Accordingly, the points not particularly mentioned may be the same as those in the tenth embodiment.

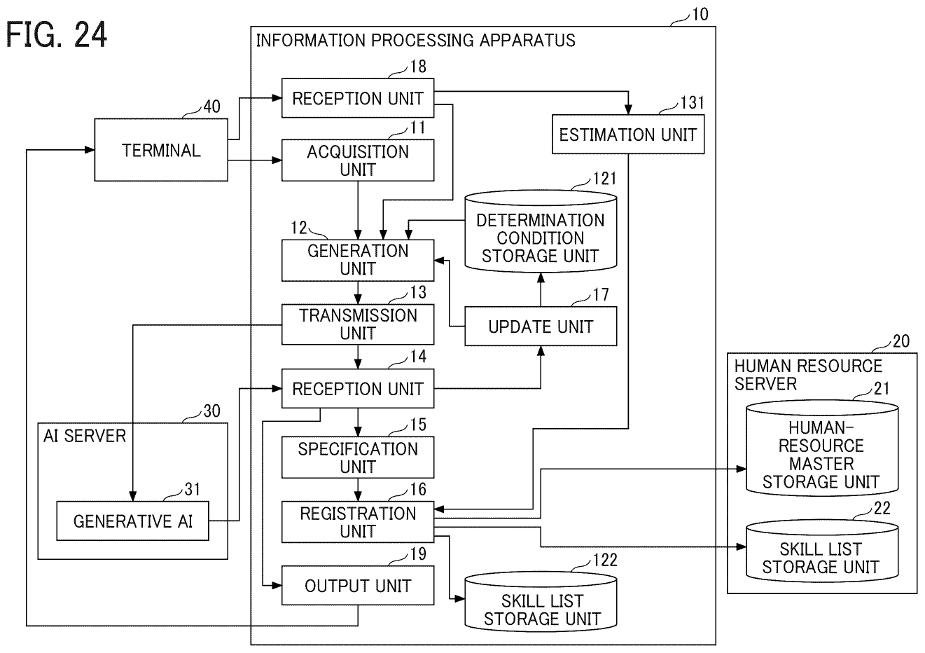

FIG. 24 is a diagram illustrating a functional configuration of an information processing system according to the eleventh embodiment. In FIG. 24, the same elements as those in FIG. 12 are denoted by the identical or similar reference signs, and descriptions thereof will be omitted.

In FIG. 24, the information processing apparatus 10 further includes an estimation unit 131. The estimation unit 131 is implemented by processing that one or more programs installed in the information processing apparatus 10 cause the CPU 101 to execute.

In the eleventh embodiment, the terminal 40 uploads data based on biological information of a target person in a period corresponding to voice data to the information processing apparatus 10. The acquisition unit 11 of the information processing apparatus 10 acquires the data. The estimation unit 131 estimates the well-being level of the target person based on the data. The well-being level is a numerical value indicating the level of well-being. The well-being refers to being in a physically, mentally, and socially good state. Accordingly, the well-being level is a numerical value indicating the level of a physically, mentally, and socially good state.

The data based on the biological information of the target person in the period corresponding to the voice data is, for example, data indicating the emotion of the target person (in the following description, referred to as “emotion data”) estimated based on the biological information of the target person in a period from the start time to the end time of the voice data (in the following description, referred to as “target period”).

The biological information of the target person during the target period can be measured using a vital sensor (biological sensor). For example, in the case of Eco moai® (fcl-components. com), biological information (pulse information) is measured, and emotion information such as “concentration,” “drowsiness (boredom, laziness),” “activity (tension, vitality),” and “tiredness” may be generated in time series. The terminal 40 uploads the time-series emotion data to the information processing apparatus 10 as data based on the biological information. Alternatively, the terminal 40 may upload data (in the following description, referred to as “biological data”) in which time-series biological information measured by another vital sensor is recorded to the information processing apparatus 10 as data based on the biological information. The emotion data or the biological information is uploaded together with the voice data. Alternatively, the emotion data or the biological data may be uploaded separately from the voice data.

When the biological data is uploaded, the estimation unit 131 estimates the emotion data from the biological data. The estimation of the emotion data from the biological data can be performed using a known technique.

Machine learning can be used for the estimation of the well-being level based on the emotion data by the estimation unit 131. A machine learning model (e.g., a neural network) that receives emotion data as input and outputs a well-being level is learned using learning data. The learning data is a set of emotion data as input data and a well-being level as a correct label (correct value) for an output. The input data may include, e.g., an average value of working hours, and information on possessed skills. The machine learning model can be trained by updating the learning parameters of the machine learning model so that the output from the machine learning model to which the input data of the training data is input approaches the correct label of the training data. The estimation unit 131 inputs, e.g., the emotion data of the target person to the trained machine learning model, and acquires an output from the machine learning model as the well-being level of the target person. Alternatively, the estimation unit 131 may instruct the generative AI 31 to estimate the well-being level based on the emotion datum. In this case, the estimation unit 131 acquires the well-being level from the response from the generative AI 31. Alternatively, the estimation unit 131 may calculate the well-being level from the emotion data using another known method.

The registration unit 16 registers the emotion data and the well-being level estimated by the estimation unit 131 from the emotion data in the human-resource master storage unit 21 in association with the target person. In other words, in the eleventh embodiment, the human-resource master storage unit 21 further stores the history of the emotion data and the well-being level for each salesperson. The history of emotion data and well-being level refer to a history of emotion data uploaded (or estimated from biological information) and a history of well-being level estimated based on each emotion data.

In the eleventh embodiment, the configuration of the human-resource information screen displayed when the button 552 is pressed and the configuration of the department information screen displayed when the button 553 is pressed in the human-resource portal screen 550 (illustrated in FIG. 20) are different from those of the tenth embodiment.

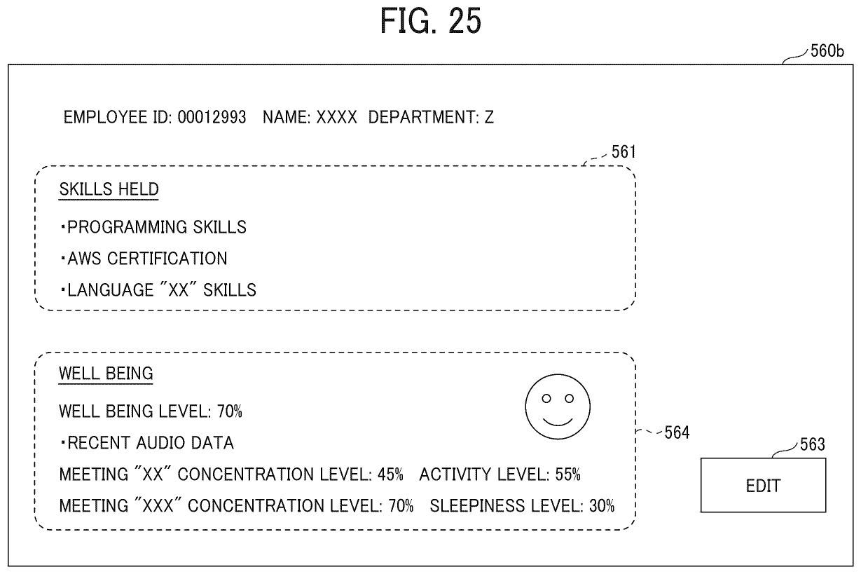

FIG. 25 is a diagram illustrating a display example of a personal information screen according to the eleventh embodiment. In FIG. 25, the same elements as those in FIG. 21 are denoted by the identical or similar reference signs, and descriptions thereof will be omitted.

As illustrated in FIG. 25, the human-resource information screen 560b includes an area 564 instead of the area 562. The area 564 includes the latest well-being level (%) of the target person and the emotion information of the latest K times (two times in the example of FIG. 25). The emotion information displayed in the area 564 indicates the proportion of the most dominant emotion in the target period in the time-series emotion data of the target period.

However, the emotion information may be expressed by other methods. In order to enable such display, the output unit 19 acquires the histories of the well-being level and the emotion data of the target person, not the history information, from the human-resource master storage unit 21, and transmits the histories to the terminal 40.

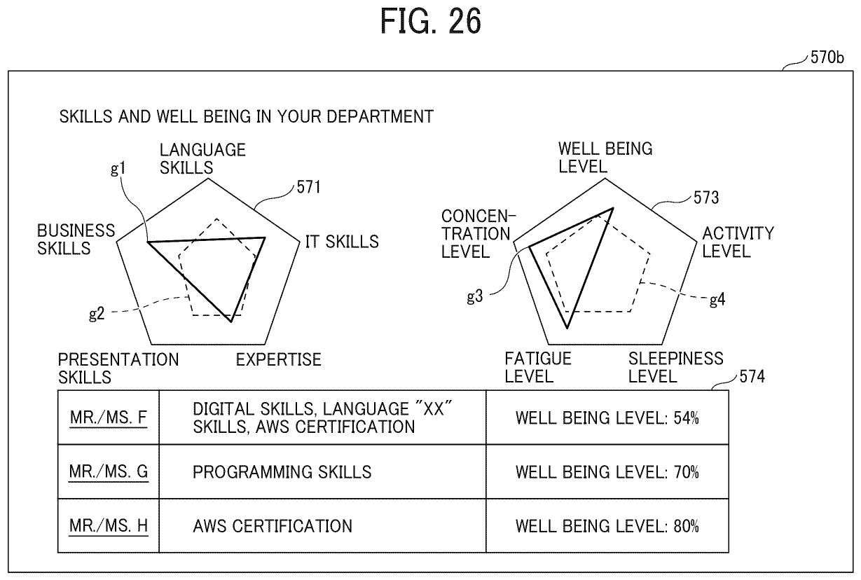

FIG. 26 is a diagram illustrating a display example of a department information screen according to the eleventh embodiment. In FIG. 26, the same elements as those in FIG. 22 are denoted by the identical or similar reference signs, and descriptions thereof will be omitted. As illustrated in FIG. 26, the department information screen 570b further includes a radar chart 573. The table 574 is included instead of the table 572.

The radar chart 573 is a radar chart where each axis is assigned either a well-being level or emotional data (concentration level, fatigue level, drowsiness level, and activity level). The radar chart 573 displays a graph g3 corresponding to the target department and a graph g4 corresponding to the entire Organization X. The values in the graph g3 of a certain axis of the radar chart 573 are average values of the values corresponding to the axis, which are stored in the human-resource master storage unit 21 for the respective salespersons belonging to the target department. The values in the graph g4 of a certain axis of the radar chart 573 are average values of the values corresponding to the axis, which are stored in the human-resource master storage unit 21 for each salesperson belonging to the organization X.

The table 574 includes the name, the skill list information, and the well-being level of each salesperson of the target department. In the table 574, the name of each salesperson is linked to the personal information of the salesperson. Accordingly, when any one of the names is clicked, the personal information screen of the salesperson corresponding to the name is displayed on the terminal 40.

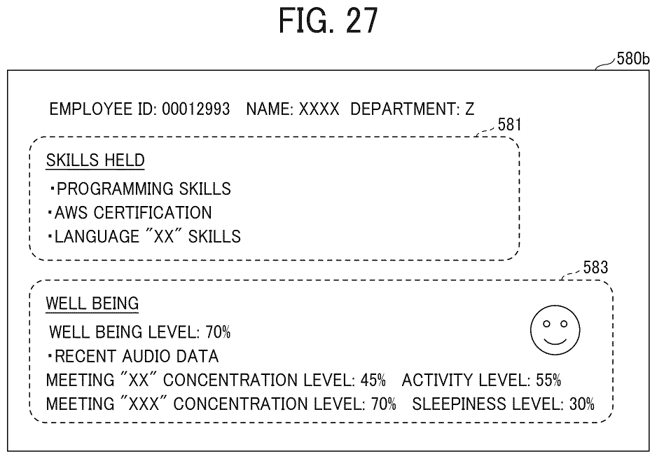

FIG. 27 is a diagram illustrating a display example of a personal information screen according to the eleventh embodiment. In FIG. 27, the same elements as those in FIG. 23 are denoted by the identical or similar reference signs, and descriptions thereof will be omitted. As illustrated in FIG. 27, the individual information screen 580a includes an area 583 instead of the area 582. The area 583 includes information similar to the identity information screen 564b with respect to the target salesperson.

As described above, according to the eleventh embodiment, not only the skill of the employee but also the information on the well-being can be checked. In addition, not only the information on the skill but also information on well-being (a well-being level) can be included in the human-resource information. In the related art, it is not considered that the skills of the employees and the information on the well-being are managed by one system. The present embodiment is intended to visualize information on skills and well-being. Another object of the present invention is to manage information on skills and well-being in a unified manner.

A twelfth embodiment is described below. In the twelfth embodiment, points different from the tenth or eleventh embodiment (or points not clearly described) will be described. Accordingly, the points not particularly mentioned may be the same as those of the tenth or eleventh embodiment.

In the twelfth embodiment, an example in which the terminal 40 displays various screens by the web browser 41 and the information processing apparatus 10 has a function as a web server that executes a web application will be described.

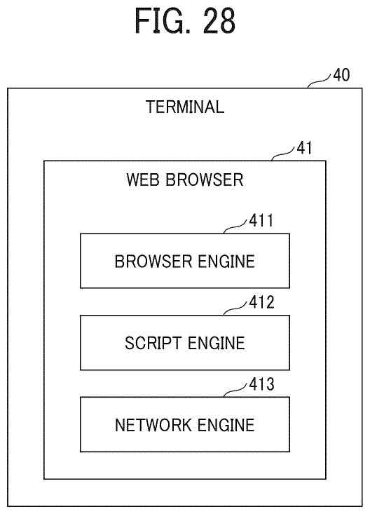

FIG. 28 is a diagram illustrating an example of a functional configuration of the terminal 40 according to the twelfth embodiment. In FIG. 28, the terminal 40 includes a web browser 41. The web browser 41 is a general web browser, and includes a browser engine 411, a script engine 412, and a network engine 413.

The browser engine 411 interprets hyper text markup language (HTML) data and cascading style sheets (CSS) data constituting a web page, and displays the web page.

The script engine 412 executes a script (for example, JavaScript®) constituting a web page.

The network engine 413 transmits an HTTP request and receives an HTTP response.

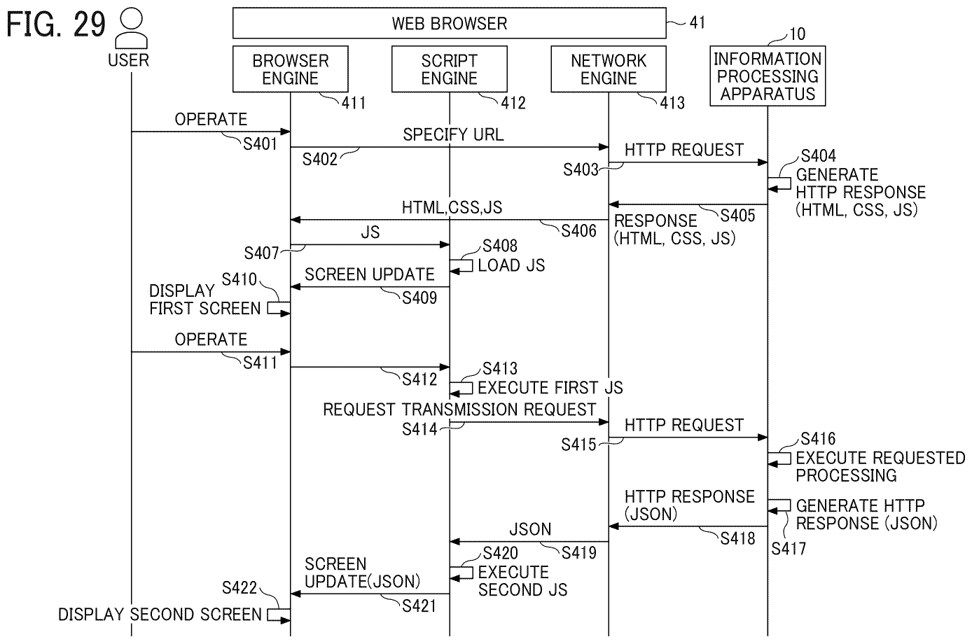

FIG. 29 is a sequence diagram illustrating a processing procedure related to screen transition according to the twelfth embodiment. The sequence diagram of FIG. 29 illustrates a processing procedure related to screen transition from the human-resource portal screen 550 (illustrated in FIG. 20) with a state in which the human-resource portal screen 550 is displayed on the terminal 40 as an initial state.

In step S401, when the user presses any button on the human-resource portal screen 550, in step S402, the browser engine 411 inputs the URL associated with the button to the network engine 413. In step S403, the network engine 413 transmits an HTTP request to the URL.

In step S403, in response to the HTTP request, the output unit 19 of the information processing apparatus 10 generates an HTTP response including a URL to which the HTTP request is addressed and a script (in the following description, referred to as “JS”). The web content is web content for displaying two web pages, that is, a web page as a first screen and a web page as a second screen. The JS includes a first JS that executes processing according to an operation on the first screen and a second JS that executes table processing of the second screen.

When the button 551 is pressed in the step S401, the search condition input screen 510 (illustrated in FIG. 14) is the first screen, and the search result screen 520 (illustrated in FIG. 15) is the second screen.

When the button 553 is pressed, the department information screen 570a (illustrated in FIG. 22) or the department information screen 570b (illustrated in FIG. 26) is the first screen, and the individual information screen 580a (illustrated in FIG. 23) or the individual information screen 580b (illustrated in FIG. 27) is the second screen.

In step S405, the output unit 19 transmits the HTTP response generated in step S404 to the terminals 40.

In step S406, the network engine 413 of the terminal 40 receives the HTTP response and inputs the HTML data, the CSS data, and the JS included in the HTTP response to the browser engine 411. In step S407, the browser engine 411 inputs the JS input from the network engine 413 to the script engine 412. In step S409, the script engine 412 loads the JS (S408) and requests the browser engine 411 to update the screen. Updating the screen includes displaying a new screen.

The HTTP response generated in step S404 may include the filename of the JS instead of the actual JS. In this case, in step S408, the script engine 412 accesses the external file based on the file name, and downloads the JS. This method is a method of reading JS as an external file.

In step S410, the browser engine 411 displays the first screen based on the HTML data and the CSS data.

In step S411, when the user performs a predetermined operation on the first screen, in step S412, the browser engine 411 notifies the script engine 412 of the execution of the predetermined operation and input data related to the predetermined operation.

When the first screen is the search condition input screen 510 (illustrated in FIG. 14), the input of the search condition is the execution of the predetermined operation, and the search condition is the input data. When the first screen is the department information screen 570a (illustrated in FIG. 22) or the department information screen 570b (illustrated in FIG. 26), clicking on any of the names in the table 572 or the table 524 is the execution of the predetermined operation, and the employee ID corresponding to the clicked name is the entry datum.

In step S413, in response to the notification from the browser engine 411, the script engine 412 executes the first JS. In step S414, thereby inputting a transmission request of an HTTP request corresponding to the predetermined operation and input data to the network engine 413. In step S415, the network engine 413 transmits the HTTP request to the information processing apparatus 10.

In step S416, when the reception unit 18 of the information processing apparatus 10 receives the HTTP request, the information processing apparatus 10 executes the process requested by the HTTP request. When the first screen is the search condition input screen 510 (illustrated in FIG. 14), steps S302 to S306 in FIG. 13 are executed. When the first screen is the department information screen 570a (illustrated in FIG. 22), the information processing apparatus 10 acquires, from the human-resource master storage unit 21, skill list information indicating a list of skills associated with the staff ID (the staff ID of the target salesperson whose name is clicked in the table 572) included in the HTTP request and history information associated with the staff ID. When the first screen is the department information screen 570b (illustrated in FIG. 26), the information processing apparatus 10 acquires, from the human-resource master storage unit 21, skill list information indicating a list of skills associated with the employee ID (the employee ID of the target salesperson whose name is clicked in the table 574) included in the HTTP request, the latest well-being level (%) associated with the employee ID, and the emotion data of the latest K times.

In step S417, the output unit 19 generates an HTTP response including JavaScript® Object Notation (JSON) in which the processing result is described. In step S418, the output unit 19 transmits the HTTP response to the terminals 40.

In step S419, when the network engine 413 of the terminal 40 receives the HTTP response, the network engine 413 inputs the JSON included in the HTTP response to the script engine 412. In step S420, the script engine 412 executes the second JS, thereby requesting the browser engine 411 to update the display content of the web page based on the JSON in step S421. In step S422, the browser engine 411 displays the second screen (the search result screen 520 (illustrated in FIG. 15), the individual information screen 580a (illustrated in FIG. 23), or the individual information screen 580b (illustrated in FIG. 27)) based on the HTML data and the CSS data acquired in step S406 and the JSON.

As described above, in the twelfth embodiment, the first screen and the second screen and the execution of the processing according to the operation on each of these screens are implemented by the single-page application. Specifically, when the first screen is displayed, not only the web content data for displaying the first screen but also the web content data for displaying the first screen and the second screen, which includes the JS for executing the process such as the screen transition according to the operation on the first screen, is distributed to the terminal 40. Therefore, since the screen transition from the first screen to the second screen is executed by the JS, the terminal 40 does not need to download the web content data of the second screen. As a result, the solution of the technical problems such as the enhancement of the display speed of the second screen and the reduction of the communication load in the screen transition can be expected.

Note that, although the example in which the organization X is a company that sells cosmetics and the skill of each salesperson is specified has been described above, the technology of the present embodiment is also applicable to other fields as long as the fields are basically fields in which the skill can be estimated from a conversation. In other words, the technology of the present embodiment may be applied to other fields as long as the skill of the target person can be specified based on the content of the speech when the target person tells something to another person.

For example, the skills (e.g., presentation skill, facilitation skill, planning construction ability, and familiarity with AI) of the business designer may be specified based on the content of the speech of the business designer. In addition, the skill of the teacher (e.g., whether the teacher is speaking a scenario of a public class, and whether the teacher is being taught a teaching material or a unit) may be specified based on the content of the speech of the teacher during the class. In addition, the skill of the on-site supervisor may be specified based on the contents of the on-site speech by the on-site supervisor of the construction site. In a field such as a site supervisor where a required skill may change depending on a site, position information corresponding to the site may be associated with each determination condition in the determination condition storage unit 121. In this case, the skill of the target person may be specified using a determination condition corresponding to the position where the target person (on-site supervisor) has made a speech.

In either field, the skills identified for each target person may be used in a training program for each target person. For example, a qualification system for qualification based on the possessed skill may be determined.

The skill is not limited to the skill required for a specific task, and may be defined in relation to a personal pattern, a personality, and a general-purpose task performance ability (e.g., time management ability). The time management power may be estimated from the length of the voice data.

Further, the speech data in which the speech content is recorded may be used for purposes other than the specification of the skill. For example, the information may be used as a trail of speech of a certain item.

The information processing apparatus 10 is not limited to a general-purpose server computer as long as the information processing apparatus 10 is an apparatus having an information processing function. The information processing apparatus 10 may be, e.g., an output device such as a projector (PJ), an interactive whiteboard (IWB; an electronic whiteboard having a blackboard function enabling mutual communication), or digital signage, a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

Further, each function of each embodiment may be implemented by one or more processing circuits. In this specification, the “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit modules designed to perform the recited functions.

Further, the group of devices in each embodiment is merely one of a plurality of computing environments for implementing the embodiments disclosed in this specification.

In some embodiments, the information processing apparatus 10 may include multiple computing devices, such as a server cluster. The multiple computing devices communicates with one another through any selected type of communication link including a network and a shared memory to perform the processes disclosed herein. Similarly, the human resource server 20 may include a plurality of computing devices configured to communicate with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Aspects of the present disclosure are, for example, as follows.

### Aspect 1

An information processing system includes an acquisition unit that acquires speech data including speech content of a target person whose skill is to be identified. The information processing system further includes a generation unit that generates first instruction information for instructing to output information for identifying a skill related to the speech content among a plurality of predefined skills based on the speech content included in the speech data. The information processing system further includes a transmission unit transmits the speech data and the first instruction information to a generative AI. The information processing system further includes a reception unit that receives a first response to the first instruction information from the generative AI. The information processing system further includes an identification unit that identifies one or more skills identified based on information for identifying the skill included in the first response, among the plurality of skills. The information processing system further includes a registration unit that registers the identified one or more skills and the target person in a first storage unit in association with each other.

### Aspect 2

The information processing system according to Aspect 1 further includes a second storage unit that stores, for each of the plurality of skills, correspondence information with one or more related terms. The generation unit generates, as the first instruction information for instructing to output the information for identifying the skill related to the speech content, instruction information for instructing to extract, from a set of terms included in the correspondence information, the term in which a word having a meaning identical or similar to the meaning of the term is included in the speech data.

### Aspect 3

In the information processing system according to Aspect 2, the generation unit further generates a second prompt for instructing generation of one or more terms related to each of the plurality of skills based on one or more pieces of latest information related to the plurality of skills and the correspondence information. The transmission unit further transmits the second prompt to the generative AI. The reception unit further receives a second response from the generative AI that received the second prompt. The information processing system further includes an update unit that updates the correspondence information for each of the plurality of skills based on the one or more terms included in the second response.

### Aspect 4

In the information processing system according to Aspect 1, the generation unit generates, as the first instruction information, instruction information for instructing to output information for identifying a skill related to the speech content based on a condition related to speech content for determining that the user has the skill, which is set for each of the plurality of skills, and speech content included in the speech data.

### Aspect 5

In the information processing system according to Aspect 2 or 3, the plurality of skills and the correspondence information are defined in advance for each attribute of the target person. The generation unit and the identification unit use the correspondence information corresponding to the attribute to which the target person belongs.

### Aspect 6

In the information processing system according to Aspect 2 or 3, the second storage unit stores a keyword in association with the correspondence information for each skill. The generation unit generates, as the first instruction information, instruction information for instructing to extract, from a set of terms included in the correspondence information, a term that corresponds to a skill related to the keyword included in the speech data and that includes a word having a common meaning in the speech data.

### Aspect 7

In the information processing system according to Aspect 3, the update unit updates the correspondence information when an input indicating permission of update of the correspondence information has been performed by a user.

### Aspect 8

The information processing system according to any one of Aspects 1 to 7 further includes a reception unit that receives a search condition described in a natural language. The generation unit further generates a third prompt for instructing to search for an individual associated with a skill matching the search condition, based on the search condition and the information stored in the first storage unit. The transmission unit further transmits the third prompt to the generative AI. The reception unit further receives a third response from the generative AI that receives the third prompt. The information processing system further includes an output unit that outputs a search result indicated by the third response.

### Aspect 9

In the information processing system according to any one of Aspects 1 to 8, the registration unit registers skill identification information for identifying the one or more skills and target person identification information for identifying the target person in association with each other in a storage unit.

### Aspect 10

In the information processing system according to any one of Aspects 1 to 9, the generation unit generates a first prompt including the speech data and the first instruction information for instructing to output information for identifying a skill related to the speech content. The transmission unit transmits the first instruction information and the speech data to the generative AI by transmitting the generated first prompt to the generative AI.

### Aspect 11

An information processing apparatus includes an acquisition unit that acquires speech data including speech content of a target person whose skill is to be identified. The information processing apparatus further includes a generation unit that generates first instruction information for instructing to output information for identifying a skill related to the speech content among a plurality of predefined skills based on the speech content included in the speech data. The information processing apparatus further includes a transmission unit transmits the speech data and the first instruction information to a generative AI. The information processing apparatus further includes a reception unit that receives a first response to the first instruction information from the generative AI. The information processing apparatus further includes an identification unit that identifies one or more skills identified based on information for identifying the skill included in the first response, among the plurality of skills. The information processing apparatus further includes a registration unit that registers the identified one or more skills and the target person in a first storage unit in association with each other.

### Aspect 12

An information processing method includes acquiring speech data including speech content of a target person whose skill is to be identified. The information processing method further includes generating first instruction information for instructing to output information for identifying a skill related to the speech content among a plurality of predefined skills based on the speech content included in the speech data. The information processing method further includes transmitting the speech data and the first instruction information to a generative AI. The information processing method includes receiving a first response to the first instruction information from the generative AI. The information processing method further includes identifying one or more skills identified based on information for identifying the skill included in the first response, among the plurality of skills. The information processing method further includes registering the identified one or more skills and the target person in a first storage unit in association with each other.

### Aspect 13

A non-transitory recording medium stores a plurality of instructions which, when executed by one or more processors, causes the one or more processors to perform an information processing method. The information processing method includes acquiring speech data including speech content of a target person whose skill is to be identified. The information processing method includes generating first instruction information for instructing to output information for identifying a skill related to the speech content among a plurality of predefined skills based on the speech content included in the speech data. The information processing method includes transmitting the speech data and the first instruction information to a generative AI. The information processing method includes receiving a first response to the first instruction information from the generative AI. The information processing method includes identifying one or more skills identified based on information for identifying the skill included in the first response, among the plurality of skills. The information processing method includes registering the identified one or more skills and the target person in a first storage unit in association with each other.

### Aspect 14

In the information processing system according to Aspect 1, the acquisition unit acquires data based on biological information of the target person in a period corresponding to the speech data. The information processing system further includes an estimation unit that estimates a well-being level of the target person based on the data. In the information processing system, the registration unit registers the estimated well-being level and the target person in the first storage unit in association with each other.

However, in the related art, it is not possible to register the skill of the target person using the generative AI from the natural language input by, e.g., speech.

The present invention has been made in view of the above circumstances, and an object of the present invention is to register a skill using a generative AI from a natural language input by speech.

A skill can be registered using a generative AI from a natural language input by, e.g., speech.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising circuitry configured to:
acquire speech data including speech content of a target person whose skill is to be identified;
generate first instruction information for instructing to output information for identifying a skill related to the speech content among a plurality of skills that are predefined based on the speech content included in the speech data;
transmit the speech data and the first instruction information to a generative artificial intelligence (AI);
receive a first response to the first instruction information from the generative AI;
identify one or more skills among the plurality of skills based on the information for identifying the skill included in the first response; and
register the identified one or more skills and the target person in a first memory in association with each other.

2. The information processing system according to claim 1, further comprising:
a second memory that stores, for each of the plurality of skills, correspondence information indicating a correspondence of the skill with one or more related terms,
wherein the circuitry is further configured to generate, as the first instruction information, instruction information for instructing to extract, from a set of terms included in the correspondence information, the term including a word having a meaning identical or similar to the meaning of a word in the speech data.

3. The information processing system according to claim 2, wherein the circuitry is further configured to
generate a second prompt for instructing generation of one or more terms related to each of the plurality of skills based on latest information related to the plurality of skills and the correspondence information,
transmit the second prompt to the generative AI,
receive a second response from the generative AI that has received the second prompt, and
update the correspondence information for each of the plurality of skills based on the one or more terms included in the second response.

4. The information processing system according to claim 1,
wherein the circuitry is further configured to generate, as the first instruction information, instruction information for instructing to output the information for identifying a skill related to the speech content included in the speech data, based on a condition related to a speech content for determining that a user has the skill, the condition having been set for each of the plurality of skills.

5. The information processing system according to claim 2,
wherein the plurality of skills and the correspondence information are defined in advance for each attribute of the target person,
wherein the circuitry is configured to use the correspondence information corresponding to the attribute to which the target person belongs to generate the first instruction information.

6. The information processing system according to claim 2,
wherein the second memory further stores, for each of the plurality of skills, a keyword in association with the correspondence information,
wherein the circuitry is configured to generate, as the first instruction information, instruction information for instructing to extract, from the set of terms included in the correspondence information, a term that corresponds to the skill related to the keyword included in the speech data and that includes a word having a common meaning to a word in the speech data.

7. The information processing system according to claim 3,
wherein the circuitry is further configured to update the correspondence information when an input indicating permission of update of the correspondence information has been performed by a user.

8. The information processing system according to claim 1, wherein the circuitry is further configured to
receive a search condition described in a natural language,
generate a third prompt for instructing to search for an individual associated with a skill matching the search condition, based on the search condition and information stored in the first memory,
transmit the third prompt to the generative AI,
receive a third response from the generative AI that inputs the third prompt, and
output a search result indicated by the third response.

9. The information processing system according to claim 1,
wherein the circuitry is further configured to register, in the first memory, skill identification information for identifying the one or more skills and target person identification information for identifying the target person in association.

10. The information processing system according to claim 1, wherein the circuitry is configured to
generate a first prompt including the speech data and the first instruction information for instructing to output information for identifying a skill related to the speech content, and
transmit the first prompt including the speech data and the first instruction information to the generative AI.

11. The information processing system according to claim 1, wherein the circuitry is further configured to
acquire data based on biological information of the target person in a period corresponding to the speech data,
estimate a well-being level of the target person based on the data, and
register in the first memory the estimated well-being level and the target person in association with each other.

12. An information processing method comprising:
acquiring speech data including speech content of a target person whose skill is to be identified;
generating first instruction information for instructing to output information for identifying a skill related to the speech content among a plurality of skills that are predefined based on the speech content included in the speech data;
transmitting the speech data and the first instruction information to a generative AI;
receiving a first response to the first instruction information from the generative AI;
identifying one or more skills among the plurality of skills based on the information for identifying the skill included in the first response; and
registering the identified one or more skills and the target person in a first memory in association with each other.
